(19) United States
(12) Patent Application Publication
(10) Pub. No.: US 2026/0089539 A1
(43) Pub. Date: Mar. 26, 2026

(54) COMMUNICATION METHOD AND APPARATUS, DEVICE, STORAGE MEDIUM, CHIP, PRODUCT, AND PROGRAM

(71) Applicant: GUANGDONG OPPO MOBILE TELECOMMUNICATIONS CORP., LTD., Dongguan (CN)

(72) Inventor: Jinqiang XING, Dongguan (CN)

(21) Appl. No.: 19/404,191

(22) Filed: Dec. 1, 2025

Related U.S. Application Data
(63) Continuation of application No. PCT/CN2023/111092, filed on Aug. 3, 2023.

(51) Int. Cl. H04W 24/10; H04B 17/309; H04B 17/318; H04W 4/38

(52) U.S. Cl. CPC H04W 24/10; H04B 17/328; H04B 17/346; H04W 4/38

(57) ABSTRACT

A communication method includes: a first device receives first information sent by a second device. The first information is determined according to one or more first measurement results, the one or more first measurement results being determined respectively by measuring a sensing signal according to one or more pieces of sensing parameter information. The first information indicates first sensing parameter information.

### CROSS-REFERENCE TO RELATED APPLICATION

This application is a continuation of International Application No. PCT/CN2023/111092 filed on Aug. 3, 2023, the disclosure of which is hereby incorporated by reference in its entirety.

### BACKGROUND

The integration of communication and sensing is a key research field in the future mobile communication field. Its main purpose is to increase abilities of sensing the external world based on communication systems, so as to enhance the overall value of the communication systems.

In the related art, measurement of a sensing signal has low reliability.

### SUMMARY

Embodiments of the disclosure relates to the technical field of communications, and provide a communication method and apparatus, device, a storage medium, a chip, a product and a program.

In a first aspect, the embodiments of the disclosure provide a communication method including the following operation. A first device receives first information sent by a second device. The first information is determined according to one or more first measurement results, the one or more first measurement results being determined respectively by measuring a sensing signal according to one or more pieces of sensing parameter information. The first information indicates first sensing parameter information.

In a second aspect, the embodiments of the disclosure provide a communication method including the following operation. A second device sends first information to a first device. The first information is determined according to one or more first measurement results, the one or more first measurement results being determined respectively by measuring a sensing signal according to one or more pieces of sensing parameter information. The first information indicates first sensing parameter information.

In a third aspect, the embodiments of the disclosure provide a first device, including a processor, a memory and a transceiver. The memory is configured to store a computer program. The processor is configured to invoke and run the computer program stored in the memory to cooperate with the transceiver to perform an operation of: receiving first information sent by a second device, wherein the first information is determined according to one or more first measurement results, the one or more first measurement results being determined respectively by measuring a sensing signal according to one or more pieces of sensing parameter information. The first information indicates first sensing parameter information.

### BRIEF DESCRIPTION OF THE DRAWINGS

The accompanying drawings described herein are intended to provide a further understanding of the disclosure, and constitute a part of the disclosure, and the schematic embodiments of the disclosure and the description thereof are intended to explain the disclosure, and do not constitute an undue limitation of the disclosure. In the drawings:

FIG. 1 is a schematic diagram of an application scenario according to an embodiment of the disclosure;

FIG. 2 is a schematic diagram showing Integrated Sensing and Communication (ISAC) between an access network device and a terminal device according to an embodiment of the disclosure;

FIG. 3 is a schematic diagram showing ISAC between a first terminal device and a second terminal device according to an embodiment of the disclosure;

FIG. 4 is a schematic diagram showing ISAC between a first access network device and a second access network device according to an embodiment of the disclosure;

FIG. 5 is a schematic diagram showing interferences in an ISAC scenario according to an embodiment of the disclosure;

FIG. 6 is a schematic flowchart of a communication method according to an embodiment of the disclosure;

FIG. 7 is a schematic flowchart of another communication method according to an embodiment of the disclosure;

FIG. 8 is a schematic flowchart of yet another communication method according to an embodiment of the disclosure;

FIG. 9 is a schematic diagram showing an ISAC scenario between terminal devices according to an embodiment of the disclosure;

FIG. 10A is a schematic diagram showing frequency configuration according to an embodiment of the disclosure;

FIG. 10B is a schematic diagram showing another frequency configuration according to an embodiment of the disclosure;

FIG. 11 is a schematic diagram showing measurement parameter configuration according to an embodiment of the disclosure;

FIG. 12 is a schematic diagram showing measurement parameter configuration according to an embodiment of the disclosure;

FIG. 13 is a schematic diagram showing a sensing frequency different from a communication frequency according to an embodiment of the disclosure;

FIG. 14 is a schematic diagram showing a sensing window according to an embodiment of the disclosure;

FIG. 15 is a schematic diagram showing beam-based sensing according to an embodiment of the disclosure;

FIG. 16 is a schematic diagram showing another beam-based sensing according to an embodiment of the disclosure;

FIG. 17 is a schematic diagram showing ISAC and interference avoidance based on the combination of frequency and beam according to an embodiment of the disclosure;

FIG. 18 is a schematic structural diagram of a communication apparatus according to an embodiment of the disclosure;

FIG. 19 is a schematic structural diagram of another communication apparatus according to an embodiment of the disclosure;

FIG. 20 is a schematic structural diagram of a communication device according to an embodiment of the disclosure; and

FIG. 21 is a schematic structural diagram of a chip according to an embodiment of the disclosure.

### DETAILED DESCRIPTION

The technical solutions in the embodiments of the disclosure would be described below with reference to the accompanying drawings in the embodiments of the disclosure. It is apparent that the described embodiments are a part of the embodiments of the disclosure, rather than all of the embodiments. Based on the embodiments of the disclosure, all other embodiments obtained by those of ordinary skill in the art without creative effort fall within the scope of protection of the disclosure.

The technical solutions described in embodiments of the disclosure may be combined in various ways without conflict. In the description of the disclosure, “a plurality of/multiple” means two or more unless otherwise explicitly and specifically defined.

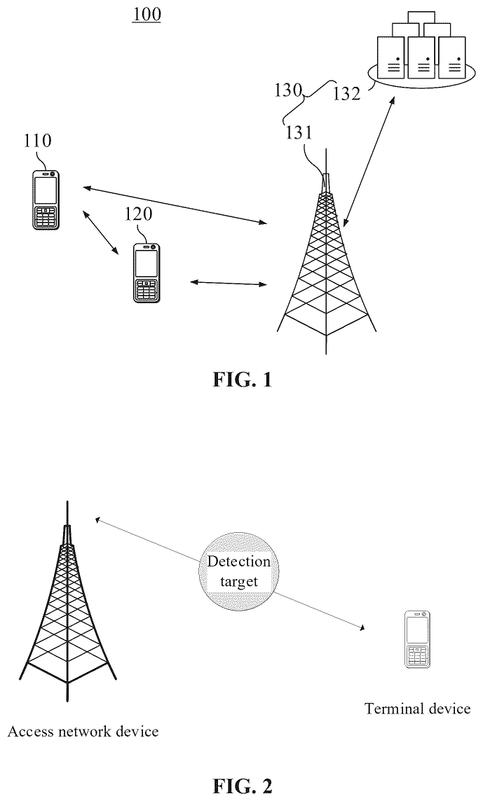

FIG. 1 is a schematic diagram of an application scenario according to an embodiment of the disclosure. As shown in FIG. 1, the communication system 100 may include a terminal device 110, a terminal device 120, and a network device 130. The network device 130 may communicate with the terminal device 110 through an air interface, and/or the network device 130 may communicate with the terminal device 120 through an air interface. Multi-service transmission is supported between the terminal device 110 and the network device 130, and/or multi-service transmission is supported between the terminal device 120 and the network device 130.

It should be understood that the embodiments of the disclosure are described only using the communication system 100 as an example, and the embodiments of the disclosure are not limited thereto. That is, the technical solutions in the embodiments of the disclosure can be applied to various communication systems, such as a Global System of Mobile communication (GSM) system, a Code Division Multiple Access (CDMA) system, a Wideband Code Division Multiple Access (WCDMA) system, a General Packet Radio Service (GPRS) system, a Long Term Evolution (LTE) system, an Advanced Long Term Evolution (LTE-A) system, a New Radio (NR) system, an evolution system of the NR system, a LTE-based access to unlicensed spectrum (LTE-U) system, a NR-based access to unlicensed spectrum (NR-U) system, a Universal Mobile Telecommunications System (UMTS), a Wireless Local Area Network (WLAN), a Wireless Fidelity (WiFi), an LTE Time Division Duplex (TDD), a Universal Mobile Telecommunications System (UMTS), an IoT system, a Narrow Band Internet of Things (NB-IoT) system, an enhanced Machine-Type Communications (eMTC) system, or a future communication system (e.g., a sixth generation (6G) communication system, a seventh generation (7G) communication system), or the like.

The network device 130 in the embodiments of the disclosure may include an access network device 131 and/or a core network device 132. The access network device may provide communication coverage for a particular geographic area and may communicate with a terminal device (e.g., UE) 110 located within the coverage area.

The terminal device in any embodiment of the disclosure may be a device having a wireless communication function, which may be deployed on land, including indoor or outdoor environments, or may be handheld or vehicle-mounted; the device may also be deployed on the water (such as on ships); and the device may further be deployed in the air (such as on aircrafts, balloons and satellites). The terminal device in any embodiment of the disclosure may be referred to as User Equipment (UE), a Mobile Station (MS), a Mobile Terminal (MT), a user unit, a user station, a remote station, a remote terminal device, a mobile device, a user terminal, a terminal, a wireless communication device, a user agent, or a user device. The terminal device in any embodiment of the disclosure may include one or a combination of at least two of the following: an Internet of Things (IoT) device, a satellite terminal, a Wireless Local Loop (WLL) station, a Personal Digital Processing (PDA) device, a handheld device having a wireless communication function, a computing device or other processing devices connected to a wireless modem, a server, a mobile phone, a tablet computer (or Pad), a translation machine, a translation pen, a learning machine, a computer with wireless transceiver function, a handheld computer, a desktop computer, a portable media player, a smart speaker, a navigation apparatus, a wearable device (such as a smart watch, a smart glass, or a smart necklace), a pedometer, a digital TV, a Virtual Reality (VR) terminal device, an Augmented Reality (AR) terminal device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, and a vehicle, an on-board device, an on-board module, a wireless modem, a handheld device, a Customer Premise Equipment (CPE), a smart attribution appliance or the like in a Vehicle to everything (V2X) system.

Optionally, the terminal device may be any terminal device, including but not limited to, a terminal device connected to a network device or another terminal device using a wired or wireless connection.

Optionally, the terminal device may be used for Device to Device (D2D) communication. For example, the terminal device 110 may communicate wirelessly with the terminal device 120.

In any embodiment of the disclosure, the access network device may include one or a combination of at least two of the following: an Evolutional Node B (eNB or eNodeB) in the LTE system, a Next Generation Radio Access Network (NG RAN) device, a base station (gNB) in the NR system, a small station, a micro station, a radio controller in a Cloud Radio Access Network (CRAN), an access point of the Wi-Fi, a transmission reception point (TRP), a relay station, an access points, an on-board device, a wearable device, a hub, a switch, a bridge, a router, a network device in a future evolved Public Land Mobile Network (PLMN), or the like.

In any embodiment of the disclosure, the core network device may be a 5th Generation (5G) core network (5G Core, 5GC) device, and the core network device may include one of or a combination of at least two of the following: a Sensing Function (SF), an Access and Mobility Management Function (AMF), an Authentication Server Function (AUSF), a User Plane Function (UPF), a Session Management Function (SMF), a Location Management Function (LMF), and a Policy Control Function (PCF). In other embodiments, the core network device may also be an Evolved Packet Core (EPC) device of the LTE network, for example, a Session Management Function+Core Packet Gateway (SMF+PGW-C) device. It should be understood that the SMF+PGW-C can achieve functions that can be achieved by the SMF and the PGW-C. In the process of network evolution, the core network devices may be called by other names, or a new network entity may be formed by dividing the functions of the core network, which is not limited in the embodiments of the disclosure.

The respective functional units in the communication system can also establish a connection through a next generation (NG) network interface to implement communication.

For example, the terminal device establishes an air interface connection with the access network device through an NR interface for transmission of user plane data and control plane signaling. The terminal device may establish a control plane signaling connection with the AMF through an NG interface 1 (N1 for short). The access network device, such as a next generation radio access base station (gNB), may establish a user plane data connection with the UPF through an NG interface 3 (N3 for short). The access network device may establish a control plane signaling connection with the AMF through an NG interface 2 (N2 for short). The UPF may establish a control plane signaling connection with the SMF through an NG interface 4 (N4 for short). The UPF may interact user plane data with a data network through an NG interface 6 (N6 for short). The AMF may establish a control plane signaling connection with the SMF through an NG interface 11 (N11 for short). The SMF may establish a control plane signaling connection with the PCF through an NG interface 7 (N7 for short).

FIG. 1 exemplarily illustrates one base station, one core network device, and two terminal devices. Alternatively, the wireless communication system 100 may include a plurality of base station devices and another number of terminal devices may be included within the coverage range of each base station. The embodiments of the disclosure are not limited thereto.

It should be noted that FIG. 1 only illustrates a system applicable to the disclosure in the form of an example, and of course, the methods shown in the embodiments of the disclosure can also be applied to other systems. In addition, the terms “system” and “network” may be used interchangeably in the disclosure. The term “and/or” used therein is only an association relationship between objects, and indicates that there may be three kinds of relationships. For example, A and/or B may indicate that A exists alone, A and B exist simultaneously, and B exists alone. In addition, the character “/” in this article generally indicates that the related objects before and after this character are in an “or” relationship. It should be further understood that in the embodiments of the disclosure, the “indication” mentioned may be a direct indication, an indirect indication, or may represent that there is an association relationship. For example, A indicates B, which may represent that A directly indicates B, for example, B can be acquired by A; it may also represent that A indicates B indirectly, for example A indicates C, and B can be acquired through C; and it may also represent that there is an association relationship between A and B. It should also be understood that the term “corresponding to” in the embodiments of the disclosure may represent that there is a direct correspondence or an indirect correspondence between two objects, or may further represent that there is an association relationship between the two objects, or may represent a relationship of indicating and being indicated, or configuring and being configured, etc. It should be also understood that “predefined”, “agreed in a protocol”, “predetermined” or “predefined rule(s)” may be realized by storing corresponding codes, tables, or other methods that can be used to indicate relevant information in advance in devices (including, for example, terminal devices and network devices), and the disclosure does not limit specific implementation methods thereof. For example, the term “predefined” may mean that it is defined in a protocol. It should be also understood that in the embodiments of the disclosure the “protocol” may refer to a standard protocol in the communication field, and may include, for example, an LTE protocol, an NR protocol, and related protocols applied to future communication systems, which is not limited in the disclosure.

The integration of communication and sensing causes a communication system to no longer merely perform transmission of data. Another key content is to use signals sent by communication base stations or terminals to perform at least one of: detecting objects (also referred to as sensed objects), tracking objects, or identifying objects.

FIG. 2 is a schematic diagram showing Integrated Sensing and Communication (ISAC) between an access network device and a terminal device according to an embodiment of the disclosure. As shown in FIG. 2, in some embodiments, the access network device sends a sensing signal, the terminal device receives the sensing signal, and the terminal device determines characteristic information of a sensed object (also referred to as a detection target) according to the received sensing signal. In some embodiments, the terminal device sends the sensing signal, the access network device receives the sensing signal, and the access network device determines characteristic information of the sensed object according to the received sensing signal.

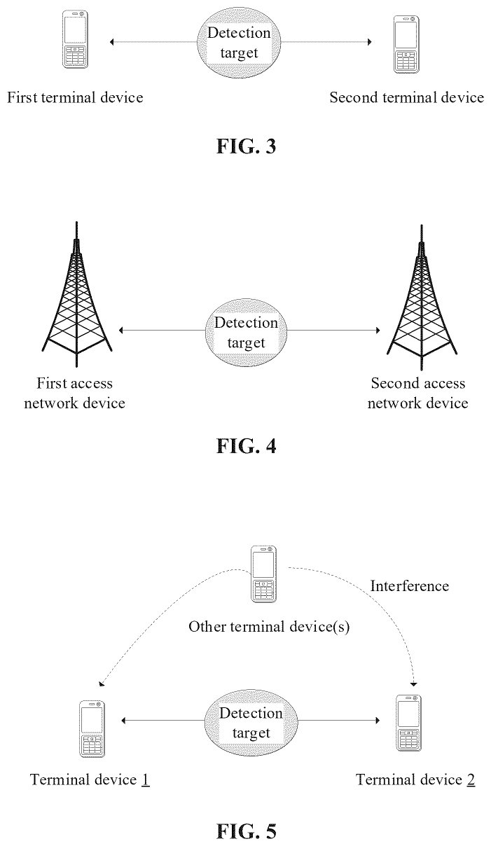

FIG. 3 is a schematic diagram showing ISAC between a first terminal device and a second terminal device according to an embodiment of the disclosure. As shown in FIG. 3, in some embodiments, the first terminal device sends a sensing signal, the second terminal device receives the sensing signal, and the second terminal device determines characteristic information of a sensed object (also referred to as a detection target) according to the received sensing signal. In some embodiments, the second terminal device sends the sensing signal, the first terminal device receives the sensing signal, and the first terminal device determines characteristic information of the sensed object according to the received sensing signal.

FIG. 4 is a schematic diagram showing ISAC between a first access network device and a second access network device according to an embodiment of the disclosure. As shown in FIG. 4, in some embodiments, the first access network device sends a sensing signal, the second access network device receives the sensing signal, and the second access network device determines characteristic information of a sensed object (also referred to as a detection target) according to the received sensing signal.

In some embodiments, the second access network device sends the sensing signal, the first access network device receives the sensing signal, and the first access network device determines characteristic information of the sensed object based on the received sensing signal. The integration of communication and sensing mainly includes two scenarios. One scenario is that an access network device or terminal device sends a signal that is received by another access network device or terminal device after spatial propagation, and the purpose of target detection is achieved by analyzing the received signal. The other scenario is that an access network device or terminal device sends a signal that is received by the access network device or terminal device sending the signal after spatial propagation (such as reflection), and the purpose of target detection is also achieved by analyzing the received signal.

In the integration of communication and sensing, it is more important to make full use of the existing hardware and make the communication system have sensing capabilities without increasing excessive costs. The most basic analysis method of the ISAC is to obtain the characteristics of the detection target (that is, the sensed object) by analyzing the received signal. The analyzed characteristics include at least one of: power characteristics, angle characteristics, direction characteristics, time delay, etc.

The analysis after sensing is based on the analysis of the transmitted signal. The ideal state is that the transmitted signal multiplexes the existing communication hardware, such as using the existing communication signal transmission capability to detect objects. The advantage is that there is no need to increase additional hardware costs, especially for sensing between terminal devices that are sensitive to hardware costs.

The transmitted signals of other devices in the communication system will cause certain interference to the sensing signal.

FIG. 5 is a schematic diagram showing interferences in an ISAC scenario according to an embodiment of the disclosure. As shown in FIG. 5, a target (a sensed object, also referred to as a detection target) is detected between a terminal device 1 and a terminal device 2, but at the same time, other terminal devices are communicating with another terminal device. Signals transmitted by other terminal devices may interfere with the reception and measurement of sensing signals by the terminal device 2 and the terminal device 1. If the requirement for sensing accuracy is relatively high, it means that the requirement for signal-to-noise ratio of the received signal will be relatively high. The sensing accuracy in the scenario of FIG. 5 may be difficult to meet the requirement.

In the embodiments of the disclosure, a method for high-quality ISAC and interference avoidance between devices is implemented based on existing communication hardware, such as power amplifiers and/or filters.

In order to facilitate understanding of the technical solutions of the embodiments of the disclosure, the technical solutions of the disclosure will be described in detail below with reference to specific embodiments. The solutions in any one or more of the above embodiments, as optional solutions, can be arbitrarily combined with the technical solutions of the embodiments of the disclosure, and all of them belong to the scope of protection of the embodiments of the disclosure. Embodiments of the disclosure include at least some of the following contents.

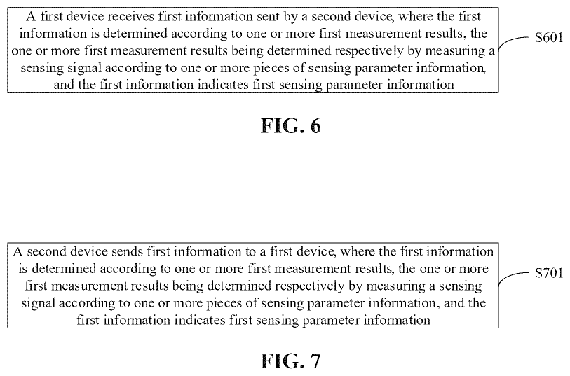

FIG. 6 is a schematic flowchart of a communication method according to an embodiment of the disclosure. As shown in FIG. 6, the method is applied to a first device, and the method includes an operation S601.

In the operation S601, a first device receives first information sent by a second device; the first information is determined according to one or more first measurement results, the one or more first measurement results being determined respectively by measuring a sensing signal according to one or more pieces of sensing parameter information; and the first information indicates first sensing parameter information.

FIG. 7 is a schematic flowchart of another communication method according to an embodiment of the disclosure. As shown in FIG. 7, the method includes an operation S701.

In operation S701, a second device sends first information to a first device; the first information is determined according to one or more first measurement results, the one or more first measurement results being determined respectively by measuring a sensing signal according to one or more pieces of sensing parameter information; and

The first information indicates first sensing parameter information.

Optionally, indicating the first sensing parameter information by the first information may include: the first information explicitly indicates the first sensing parameter information. For example, the first information includes first sensing parameter information. Optionally, the second device may determine the first sensing parameter, and then send the first sensing parameter to the first device. Optionally, the second device may determine the first sensing parameter information according to the one or more first measurement results. Optionally, the second device may determine at least one piece of sensing parameter information and/or at least one first measurement result according to the one or more first measurement results, and then determine the first sensing parameter information according to the at least one piece of sensing parameter information and/or the at least one first measurement result. Optionally, in a case where the determined at least one piece of sensing parameter information is one piece of sensing parameter information, the second device uses the one piece of sensing parameter information as the first sensing parameter information. Optionally, in a case where the determined at least one first measurement result is one first measurement result, the second device uses sensing parameter information corresponding to the one first measurement result as the first sensing parameter information.

Optionally, indicating the first sensing parameter information by the first information may include: the first information implicitly indicates the first sensing parameter information. In a case where the first information implicitly indicates the first sensing parameter information, the first information does not include the first sensing parameter information, but includes specific information, where the first sensing parameter information is determined by the specific information, or the specific information is used to determine the first sensing parameter information. Optionally, the specific information includes at least one of: at least one piece of sensing parameter information, at least one first measurement result, or the one or more first measurement results. Optionally, the at least one piece of sensing parameter information and/or the at least one first measurement may be determined by the second device according to the one or more first measurement results. Optionally, the second device sends specific information in the first information to the first device, and the first device determines the first sensing parameter according to the specific information. For example, the specific information includes one or more first measurement results, and the first device may determine the first sensing parameter information according to the one or more first measurement results. For another example, the specific information includes at least one piece of sensing parameter information and/or at least one first measurement result, and the first device determines the first sensing parameter information according to the at least one piece of sensing parameter information and/or the at least one first measurement result. Optionally, in a case where the determined at least one piece of sensing parameter information is one piece of sensing parameter information, the first device uses the one piece of sensing parameter information as the first sensing parameter information. Optionally, in a case where the determined at least one first measurement result is one first measurement result, the first device uses sensing parameter information corresponding to the one first measurement result as the first sensing parameter information.

Optionally, device types of the first device and the second device are not limited in the embodiments of the disclosure. Exemplarily, the first device is a first terminal device, and the second device is also a second terminal device. Exemplarily, the first device is a terminal device, and the second device is an access network device. Exemplarily, the first device is an access network device, and the second device is a terminal device. Exemplarily, the first device is a first access network device, and the second device is a second access network device. Exemplarily, the first device and the second device may be a same device, thus the measured sensing signal is a sensing signal reflected back by the sensed object. For example, the first device and the second device may both be a certain terminal device, or the first device and the second device may both be a certain network device.

Optionally, the first measurement result may include a signal measurement result of signal measurement performed on the sensing signal and/or an interference measurement result of interference measurement performed on the sensing signal. In this way, the first sensing parameter information is determined by the one or more first measurement results, so that the measurement of the sensing signal according to the first sensing parameter information can be less interfered with by other signals, and the reliability of communication can be improved.

In some embodiments, the sensing signal may be a signal different from the first signal. In other embodiments, the sensing signal may be the same signal as the first signal. Optionally, the first signal may include at least one of: Channel State Information Reference Signal (CSI-RS), DeModulation Reference Signal (DMRS), Phase Tracking Reference Signal (PTRS or PT-RS), Sounding Reference Signal (SRS), Synchronization Signal Block (SSB), Positioning Reference Signal (PRS), sidelink reference signal, or the like. Here, the SSB may also be referred to as Synchronization Signal/Physical Broadcast Channel Block (SS/PBCH block).

Optionally, one or more first measurement results are in one-to-one correspondence with one or more pieces of sensing parameter information. In an embodiment of the disclosure, one first measurement result may include one or more measurement values. Exemplarily, one first measurement may include a first measurement value and/or a second measurement value. Optionally, the first measurement value is related to a signal reception status. Optionally, the second measurement value is related to an interference/noise status. Optionally, the first measurement value includes a measurement value of at least one of the following, or may include a measurement value of at least one of the following for the sensing signal: signal receiving power, signal receiving quality, received signal strength, Signal to Interference plus Noise Ratio (SINR), or Signal-to-Noise Ratio (SNR). Optionally, the second measurement value includes a measurement value of at least one of the following, or may include a measurement value of at least one of the following for the sensing signal: interference strength, noise strength, interference plus noise strength, interference power, noise power, or interference plus noise power.

Optionally, the first sensing parameter information may be sensing parameter information corresponding to a first measurement result having a highest value corresponding to the signal reception status among the one or more first measurement results. Optionally, the first sensing parameter information may be sensing parameter information corresponding to a value, which corresponds to the signal reception status, greater than or equal to a first set value, among the one or more first measurement results. Optionally, the first sensing parameter information may be sensing parameter information corresponding to a first measurement result having a highest first measurement value among the one or more first measurement results. Optionally, the first sensing parameter information may be sensing parameter information corresponding to the first measurement value greater than or equal to a second set value among the one or more first measurement results. Optionally, the first sensing parameter information may be sensing parameter information corresponding to a first measurement result having a lowest second measurement value among the one or more first measurement results. Optionally, the first sensing parameter information may be sensing parameter information corresponding to the second measurement value smaller than or equal to a third set value among the one or more first measurement results.

Optionally, the one or more first measurement results may be obtained by measuring, by the second device, the sensing signal sent on the one or more pieces of sensing parameter information. Optionally, the second device may send the one or more first measurement results to the first device; or, the second device may send at least one piece of sensing parameter information to the first device, and the at least one piece of sensing parameter information is included in the one or more pieces of sensing parameter information; or, the second device may send at least one first measurement result to the first device, and the at least one first measurement result is included in the one or more first measurement results; or, the second device may send the first sensing parameter information to the first device; or the second device may send the first measurement result corresponding to the first sensing parameter information to the first device.

Optionally, the first information may include one or more first measurement results used for determining the first sensing parameter information. Optionally, the first information may include at least one piece of sensing parameter information used for determining the first sensing parameter information. Optionally, the first information may include at least one first measurement result among the one or more first measurement results, the at least one first measurement result being used for determining the first sensing parameter information. Optionally, the first information may include at least one piece of sensing parameter information and at least one first measurement result, and the at least one piece of sensing parameter information and the at least one first measurement result are used for determining the first sensing parameter information.

In the embodiments of the disclosure, the first device receives the first information sent by the second device; the first information is determined according to one or more first measurement results, the one or more first measurement results being determined respectively by measuring a sensing signal according to one or more pieces of sensing parameter information; and the first information indicates first sensing parameter information. In this way, the first information sent by the second device to the first device indicates the first sensing parameter information, and both the first device and the second device can obtain the first sensing parameter information, so that the second device can measure the sensing signal according to the first sensing parameter information, and the reliability of measurement of the sensing signal is improved.

In some embodiments, on the first device side, the method further includes: receiving, by the first device, a second measurement result sent by the second device. In some embodiments, on the second device side, the method further includes: sending, by the second device, a second measurement result to the first device. Herein, the second measurement result is a measurement result obtained by measuring the sensing signal according to the first sensing parameter information, and the second measurement result is used for determining a sensing result of a sensed object.

In this way, when obtaining the second measurement result, the second device directly sends the second measurement result to the first device, so that the first device determines a sensing result of the sensed object according to the second measurement result, and the amount of computation of the second device is reduced. In addition, in a case where the magnitude of the second measurement result is smaller than the magnitude of the sensing result of the sensed object, it is advantageous to save information transmission resources by directly sending the second measurement result.

In some embodiments, on the first device side, the method further includes: receiving, by the first device, a sensing result of the sensed object sent by the second device. In some embodiments, on the second device side, the method further includes: sending, by the second device, the sensing result of the sensed object to the first device. Herein, the sensing result of the sensed object is determined according to the second measurement result, the second measurement result being a measurement result obtained by measuring the sensing signal according to the first sensing parameter information.

In this way, when obtaining the second measurement result, the second device determines the sensing result of the sensed object according to the second measurement result, and sends the sensing result of the sensed object to the first device, thereby reducing the amount of computation of the first device. In addition, in a case where the magnitude of the second measurement result is greater than the magnitude of the sensing result of the sensed object, it is advantageous to save information transmission resources by directly sending the sensing result of the sensed object.

In some embodiments, on the first device side, the method further includes: receiving, by the first device, a first processing result sent by the second device. In some embodiments, on the second device side, the method further includes: sending, by the second device, a first processing result to the first device. Herein, the first processing result is used for determining the sensing result of the sensed object, and the first processing result is obtained by processing the second measurement result, the second measurement result being a measurement result obtained by measuring the sensing signal according to the first sensing parameter information.

In this way, when obtaining the second measurement result, the second device first performs a part of processing to obtain the first processing result, sends the first processing result to the first device, and then the first device determines the sensing result of the sensed object according to the first processing result. In this way, the first device and the second device each bear a part of the amount of computation, thereby reducing occurrence of situations of computing power shortage caused by one device bearing the entire amount of computing. Further, by transmission of the first processing result, it is possible to reduce the risk of information leakage as compared to transmission of the second measurement result or the sensing result of the sensed object. In addition, in a case where the magnitude of the first processing result is smaller than the magnitude of the second measurement result or the sensing result of the sensed object, it is advantageous to save information transmission resources by sending the first processing result.

Optionally, the sensing result of the sensed object may include a result corresponding to the characteristic information of the sensed object. The characteristic information of the sensed object will be described hereinafter.

In some embodiments, on the first device side, the method further includes: the first device sends second information, where the second information includes the first sensing parameter information, or the second information includes the first sensing parameter information and one or more pieces of second sensing parameter information.

In some embodiments, on the second device side, the method further includes: the second device receives second information sent by the first device, where the second information includes the first sensing parameter information, or the second information includes the first sensing parameter information and one or more pieces of second sensing parameter information.

The one or more pieces of second sensing parameter information are used by the second device for switching from measuring the sensing signal according to the first sensing parameter information to measuring the sensing signal according to specific sensing parameter information, the specific sensing parameter information being included in the one or more pieces of second sensing parameter information.

In an embodiment of the disclosure, the first information does not include the first sensing parameter information, but includes specific information, so that the first device determines the first sensing parameter information according to the specific information, and sends the second information including the first sensing parameter information.

Optionally, the first device may broadcast or multicast or unicast the second information. In some embodiments, in a case where the first device broadcasts/multicasts the second information, one or more devices including the second device receive the second information, and the one or more devices measure the sensing signal with the first sensing parameter information. For example, among one or more devices, a device that supports measuring the sensing signal using the first sensing parameter information measures the sensing signal with the first sensing parameter information. In some embodiments, the second device supports measuring the sensing signal with the first sensing parameter information, and the one or more devices other than the second device do not support measuring the sensing signal with the first sensing parameter information. In some embodiments, in a case where the first device unicasts the second information to the second device, the second device measures the sensing signal with the first sensing parameter information.

Optionally, in a case where the first device broadcasts or multicasts the second information, the second information may include an identifier of the second device and first sensing parameter information corresponding to the second device, or the second information may include an identifier set of the device and a sensing parameter information set. Optionally, a device identifier in the device identifier set may have a one-to-one correspondence relationship with sensing parameter information in the sensing parameter information set, or may have a one-to-many correspondence relationship with the sensing parameter information, or may have a many-to-one correspondence relationship with sensing parameter information. The identifier of the second device may be included in the identifier set, and the first sensing parameter information may be included in the sensing parameter information set.

Optionally, in any embodiment of the disclosure, the first sensing parameter information used by the second device to measure the sensing signal may be different from a communication parameter information used by the second device to communicate with the first device, or the first sensing parameter information used by the second device to measure the sensing signal may be the same as the communication parameter information used by the second device to communicate with the first device. For example, a first frequency used by the second device to measure the sensing signal may be the same as or different from a third frequency used by the second device to communicate with the first device. For another example, a spatial filter used by the second device to measure the sensing signal may be the same as or different from a spatial filter used by the second device to communicate with the first device. For another example, a first set of frequencies and spatial filters used by the second device to measure the sensing signal may be the same as or different from a third set of frequencies and spatial filters used by the second device to communicate with the first device. Optionally, in any embodiment of the disclosure, the communication between the first device and the second device may include at least one of: the first device sends third information, the second device sends first information to the first device, and the first device sends second information; the second device sends fourth information or fifth information to the first device; the first device sends sixth information; the first device sends a first request; or the second device sends seventh information to the first device.

Optionally, the frequency in any embodiment of the disclosure may be replaced with a frequency point. Optionally, the frequency in any embodiment of the disclosure may include at least one of: a frequency range, a center frequency point, an upper frequency limit, a lower frequency limit, a frequency band, or the like. For example, the frequency may be a center frequency or a center frequency point. For another example, the frequency may be a frequency range.

Optionally, the second information further includes one piece of second sensing parameter information, and the second sensing parameter information is used for the second device to switch from measuring the sensing signal with the first sensing parameter information to measuring the sensing signal at the one piece of second sensing parameter information.

Optionally, the specific sensing parameter information may be any one of the one or more pieces of second sensing parameter information.

Optionally, when receiving the second information, the second device may perform measurement on the first sensing parameter information and/or the one or more pieces of second sensing parameter information; and when a first condition is satisfied, the second device switches from measuring the sensing signal according to the first sensing parameter information to measuring the sensing signal according to the specific sensing parameter information. Optionally, the first condition may include at least one of: a first measurement value obtained by measuring the sensing signal with the first sensing parameter information is smaller than or equal to a second threshold; a second measurement value obtained by measuring the sensing signal with the first sensing parameter information is greater than or equal to the second threshold; a first measurement value obtained by measuring the sensing signal with the specific sensing parameter information is greater than or equal to the second threshold; or a second measurement value obtained by measuring the sensing signal with the specific sensing parameter information is smaller than or equal to the second threshold.

Optionally, when the first condition is satisfied, the switching, by the second device, from measuring the sensing signal according to the first sensing parameter information to measuring the sensing signal according to the specific sensing parameter information may include: when the first condition is satisfied, the second device sends, to the first device, indication information (corresponding to the eighth information described below) indicating that the first condition is satisfied; the first device sends, to the second device, instruction information (corresponding to the ninth information described below) that instructs the second device to measure the sensing signal at the specific sensing parameter information; and the second device switches from measuring the sensing signal according to the first sensing parameter information to measuring the sensing signal according to the specific sensing parameter information.

Optionally, when the first condition is satisfied, the switching, by the second device, from measuring the sensing signal according to the first sensing parameter information to measuring the sensing signal according to the specific sensing parameter information may include: when the first condition is satisfied, the second device switches from measuring the sensing signal with the first sensing parameter information to measuring the sensing signal at the specific sensing parameter information, and the second device sends, to the first device, indication information indicating that the first condition is satisfied/instruction information instructing use of the specific sensing parameter.

In some embodiments, the first information includes at least one of:
at least one piece of sensing parameter information, wherein the at least one piece of sensing parameter information is included in the one or more pieces of sensing parameter information, and the at least one piece of sensing parameter information is determined according to the one or more first measurement results;
at least one first measurement result obtained respectively by measuring the sensing signal according to the at least one piece of sensing parameter information; or
the one or more first measurement results.

Optionally, the first information includes at least one piece of sensing parameter information. Optionally, the first information includes at least one first measurement result. Optionally, the first information includes the one or more first measurement results.

Optionally, the at least one piece of sensing parameter information may include first sensing parameter information.

Optionally, the number of pieces of sensing parameter information corresponding to the at least one piece of sensing parameter information may be one or a target number. Optionally, the target number may be indicated by the first device to the second device, or the target number may be agreed by a protocol, or the target number may be determined by the second device according to pre-configuration information. In any embodiment of the disclosure, the target number may be the number of pieces of sensing parameter information corresponding to the first information in the following embodiments.

Optionally, in some embodiments, the first information may further include at least one of: Doppler shift, angle parameter, or characteristic information of the sensed object.

In an embodiment of the disclosure, the first information is sent to the first device by the second device, so that the first device can determine the second information according to the first information.

In an embodiment of the disclosure, the first information is sent to the first device by the second device, and the first information includes at least one of at least one piece of sensing parameter information or at least one first measurement result, so that the second device can filter the one or more first measurement results, and information transmission resources are saved compared with a solution where the second device directly sends, to the first device, at least one of: the one or more pieces of sensing parameter information, or the one or more first measurement results. In an embodiment of the disclosure, the first information is sent to the first device by the second device, and the first information includes one or more first measurement results, so that the second device can send the one or more first measurement results obtained by measurement to the first device, thereby saving computing resources of the second device.

In some embodiments, the at least one piece of sensing parameter information satisfies at least one of:
at least one first measurement value in one-to-one correspondence with the at least one piece of sensing parameter information is greater than or equal to the first threshold; or
at least one second measurement value in one-to-one correspondence with the at least one piece of sensing parameter information is smaller than or equal to a second threshold.

Optionally, at least one of the first measurement value or the second measurement value is included in the first measurement result.

Optionally, the first measurement value includes a measurement value of at least one of: signal receiving power, signal receiving quality, received signal strength, SINR, or SNR; the second measurement value includes a measurement value of at least one of: interference strength, noise strength, interference plus noise strength, interference power, noise power, or interference plus noise power.

Optionally, the at least one piece of sensing parameter information satisfies: at least one first measurement value in one-to-one correspondence with the at least one piece of sensing parameter information is greater than or equal to the first threshold. Optionally, the at least one piece of sensing parameter information satisfies: at least one second measurement value in one-to-one correspondence with the at least one piece of sensing parameter information is smaller than or equal to the second threshold. Optionally, the at least one piece of sensing parameter information satisfies: at least one first measurement value in one-to-one correspondence with the at least one piece of sensing parameter information is greater than or equal to the first threshold; and at least one second measurement value in one-to-one correspondence with the at least one piece of sensing parameter information is smaller than or equal to the second threshold.

Optionally, the first thresholds corresponding to measurement values of different parameters included in the first measurement values may be the same or different. For example, among the following parameters, the first thresholds corresponding to any two different parameters are different, or there are different parameters corresponding to a same first threshold: signal receiving power, signal receiving quality, received signal strength, SINR, SNR. For example, the signal receiving power and the received signal strength correspond to different first thresholds. For another example, the signal receiving power and the SNR correspond to different first thresholds.

Optionally, the second thresholds corresponding to measurement values of different parameters included in the second measurement values may be the same or different. For example, among the following parameters, the second thresholds corresponding to any two different parameters are different, or there are different parameters corresponding to a same second threshold: interference strength, noise strength, interference plus noise strength, interference power, noise power, or interference plus noise power. For example, the interference strength and the noise strength correspond to different second thresholds. For another example, the interference strength and the noise strength correspond to different second thresholds.

Optionally, the at least one piece of sensing parameter information satisfies at least one of: the signal receiving power in one-to-one correspondence with the at least one piece of sensing parameter information is greater than or equal to a first threshold corresponding to the signal receiving power; the signal receiving quality in one-to-one correspondence with the at least one piece of sensing parameter information is greater than or equal to a first threshold corresponding to the signal receiving quality; the received signal strength in one-to-one correspondence with the at least one piece of sensing parameter information is greater than or equal to a first threshold corresponding to the received signal strength; the SINR in one-to-one correspondence with the at least one piece of sensing parameter information is greater than or equal to a first threshold corresponding to the SINR; the SNR in one-to-one correspondence with the at least one piece of sensing parameter information is greater than or equal to a first threshold corresponding to the SNR; the interference strength in one-to-one correspondence with the at least one piece of sensing parameter information is smaller than or equal to a second threshold corresponding to the interference strength; the noise strength in one-to-one correspondence with the at least one piece of sensing parameter information is smaller than or equal to a second threshold corresponding to the noise strength; the interference plus noise strength in one-to-one correspondence with the at least one piece of sensing parameter information is smaller than or equal to a second threshold corresponding to the interference plus noise strength; the interference power in one-to-one correspondence with the at least one piece of sensing parameter information is smaller than or equal to a second threshold corresponding to the interference power; the noise power in one-to-one correspondence with the at least one piece of sensing parameter information is smaller than or equal to a second threshold corresponding to the noise power; or the interference plus noise power in one-to-one correspondence with the at least one piece of sensing parameter information is smaller than or equal to a second threshold corresponding to the interference plus noise power. For example, the at least one piece of sensing parameter information satisfies: the signal receiving power in one-to-one correspondence with the at least one piece of sensing parameter information is greater than or equal to the first threshold corresponding to the signal receiving power. For another example, the at least one piece of sensing parameter information satisfies: at least one interference strength in one-to-one correspondence with the at least one piece of sensing parameter information is smaller than or equal to the second threshold corresponding to the interference strength.

In some embodiments, on the first device side, the method further includes: sending, by the first device, third information. In some embodiments, on the second device side, the method further includes: receiving, by the second device, the third information sent by the first device. Herein, the third information is used for instructing the second device to measure the sensing signal.

Optionally, the first device may broadcast or multicast or unicast the third information. In some embodiments, in a case where the first device broadcasts/multicasts the third information, one or more devices including the second device receive the third information; and each of the one or more devices measures the sensing signal with the first sensing parameter information, and sends corresponding first information to the first device. The first information sent by different devices may be the same or different. Optionally, the third information may include a first number of pieces of sensing parameter information, and the second device determines one or more pieces of sensing parameter information from the first number of pieces of sensing parameter information, and then measures the sensing signal according to the one or more pieces of sensing parameter information to obtain the one or more first measurement results. Optionally, the third information may not include the first number of pieces of sensing parameter information, and the second device measures the sensing signal according to supported one or more pieces of sensing parameter information to obtain the one or more first measurement results.

Optionally, in a case where the first device broadcasts or multicasts the third information, the third information may include an identifier of the second device and/or several pieces of sensing parameter information corresponding to the second device (which may be a first number of pieces of sensing parameter information, or may be a subset of the first number of pieces of sensing parameter information, or may be one or more pieces of sensing parameter information); or, the third information may include a set of device identifiers and/or a set of corresponding several pieces of sensing parameter information (which may be a first number of pieces of sensing parameter information, or may be a subset of the first number of pieces of sensing parameter information, or may be one or more pieces of sensing parameter information). Optionally, a device identifier in the device identifier set may have a one-to-one correspondence relationship with sensing parameter information in the sensing parameter information set, or may have a one-to-many correspondence relationship with the sensing parameter information, or may have a many-to-one correspondence relationship with sensing parameter information. The identifier of the second device may be included in the set of identifiers, and one or more pieces of sensing parameter information may be included in the set of sensing parameter information.

In some embodiments, the third information includes at least one of: first sensing configuration information, first measurement configuration information, identification information of the second device, reporting type configuration information of the first information, configuration information for a first window where the sensing signal is measured, configuration information for a second window where the first information is reported, configuration information for a third window where the sensing signal is measured and the first information is reported, or a number of pieces of sensing parameter information corresponding to the first information.

It is to be noted that the embodiments of the disclosure do not limit content included in the third information and specified in the protocols, and the third information may include any one or more of the above-mentioned items, and the third information may include all or a part of the above-mentioned items. For example, optionally, the third information may include the identification information of the second device, or may not include the identification information of the second device. For example, optionally, the third information may include the configuration information for the first window and the configuration information for the second window, and may not include the configuration information for the third window. For example, optionally, the third information may include the configuration information for the third window, but does not include the configuration information for the first window and the configuration information for the second window.

Optionally, the first device may unicast or multicast or broadcast the third information. Optionally, in a case where the first device unicasts the third information to the second device, the second device may measure the sensing signal and perform reporting according to the third information. For example, the second device may measure the sensing signal and perform reporting according to the configuration information of the second device and the received third information. Optionally, in a case where the first device unicasts the third information to the second device, the third information may or may not include identification information of the second device. Optionally, in a case where the first device multicasts or broadcasts the third information, one or more devices (including the second device) may measure the sensing signal and perform reporting according to the third information and their respective configuration information. For example, when the measurement parameters supported by the second device include signal receiving power, signal receiving quality, Doppler shift, angle parameter, and characteristic information of the sensed object, the second device performs measurement and reporting according to the measurement parameters supported by the second device; when the measurement parameters supported by the third device include interference strength, noise strength, and characteristic information of the sensed object, the third device performs measurement and reporting according to the measurement parameters supported by the third device. Optionally, in a case where the first device multicasts or broadcasts the third information to the second device, the third information may or may not include the identification information of the second device.

Optionally, the first sensing configuration information includes a first set including a first number of pieces of sensing parameter information. Optionally, the first number may be an integer greater than or equal to 1. Optionally, in some embodiments, the first number of pieces of sensing parameter information include the one or more pieces of sensing parameter information. Optionally, in some embodiments, the first number of pieces of sensing parameter information do not include the one or more pieces of sensing parameter information, or the first number of pieces of sensing parameter information include part of the one or more pieces of sensing parameter information.

Optionally, the first device sends the first sensing configuration information, so that the second device can measure the sensing signal according to the sensing parameter information in the first sensing configuration information.

Optionally, the first measurement configuration information includes at least one of: signal receiving power, signal receiving quality, received signal strength, SINR, SNR, interference strength, noise strength, interference plus noise strength, interference power, noise power, interference plus noise power, Doppler shift, angle parameter, or characteristic information of a sensed object. The embodiments of the disclosure do not limit the specific contents included in the first measurement configuration information, and the contents included in the first measurement configuration information may be any one or more of the above-mentioned items.

Optionally, at least one of signal receiving power, signal receiving quality, received signal strength, SINR, SNR, interference strength, noise strength, interference plus noise strength, interference power, noise power or interference plus noise power is used for determining the status of interference experienced during propagation of the sensing signal.

Optionally, at least one of the Doppler shift, the angle parameter or the characteristic information of the sensed object is used for determining relevant information of the sensed object. For example, by measuring the Doppler shift, it is possible to determine at least one of: information on whether the sensed object is moving, a moving direction, a moving speed, a moving path of the sensed object, or the like. Optionally, the Doppler shift may be replaced with a Doppler spread. For another example, by measuring the angle parameter, information about angle between the second device and the sensed object can be determined, and the information about may include at least one of azimuth angle, or elevation angle.

Optionally, the characteristic information of the sensed object may include at least one of: shape, distribution, size, number, temperature of the sensed object, an action behavior of the sensed object, a respiratory rate of the sensed object, a heart rate of the sensed object, position information of the sensed object, region information of the sensed object, or attribute information of the sensed object. For example, the position information of the sensed object may include at least one of: position coordinates, a position identifier, or a position name. For example, the region information of the sensed object may include at least one of: coordinates and radius of a reference point; coordinates of the reference point, region length, and region width; one or more region Identifiers (IDs); or 3GPP region IDs. For example, the attribute information of the sensed object may include at least one of: person, animal, matter, space, geographical area, or the like.

Optionally, the reporting type configuration information of the first information includes one of: configuration information for periodic reporting, and configuration information for event-triggered reporting. Optionally, in a case where the reporting type configuration information of the first information includes configuration information for periodic reporting, devices (including the second device) that receive the first configuration information periodically report the first information to the first device. Optionally, the configuration information for periodic reporting may include at least one of: a start time at which the first information is reported, an end time at which the first information is reported, or reporting period for the first information. Optionally, when the reporting type configuration information of the first information includes the configuration information for event-triggered reporting, the devices (including the second device) that receive the first configuration information report the first information to the first device when the event is satisfied.

Optionally, in any of the embodiments of the disclosure, the start time and/or the end time may include a time unit, or a start position of the time unit, or an end position of the time unit. Optionally, the time unit may include one of: frame, subframe, slot, and symbol. In any of the embodiments of the disclosure, the period and/or window length may include at least one of: one or more frames, one or more subframes, one or more slots, or one or more symbols.

Optionally, the configuration information for the first window includes at least one of: a length of the first window, a period of the first window, a start time of the first window, or an end time of the first window. Optionally, the devices (including the second device) that receive the first configuration information measure the sensing signal in the first window.

Optionally, the configuration information for the second window includes at least one of: a length of the second window, a period of the second window, a start time of the second window, or an end time of the second window. Optionally, the devices (including the second device) that receive the first configuration information report the first information in the second window.

Optionally, the configuration information for the third window includes at least one of: a length of the third window, a period of the third window, a start time of the third window, or an end time of the third window. Optionally, the devices (including the second device) that receive the first configuration information measure the sensing signal and report the first information in the third window.

In some embodiments, on the first device side, the method further includes: receiving, by the first device, fourth information or fifth information sent by the second device.

In some embodiments, on the second device side, the method further includes: sending, by the second device, the fourth information or fifth information to the first device.

Optionally, the fourth information is used for indicating at least one of:
first measurement values corresponding to at least part of the sensing parameter information in the first set are greater than or equal to a first threshold; or
second measurement values corresponding to at least part of the sensing parameter information in the first set are smaller than or equal to a second threshold.

Optionally, the fifth information is used for indicating at least one of:
first measurement values corresponding to all of the sensing parameter information in the first set are smaller than the first threshold; or
second measurement values corresponding to all of the sensing parameter information in the first set are greater than the second threshold.

Optionally, at least one of the first measurement value or the second measurement value is included in the first measurement result.

Optionally, the first measurement value includes a measurement value of at least one of: signal receiving power, signal receiving quality, received signal strength, SINR, or SNR.

Optionally, the second measurement value includes a measurement value of at least one of: interference strength, noise strength, interference plus noise strength, interference power, noise power, or interference plus noise power.

Optionally, if the second device sends the fourth information, it indicates that the second device supports at least part of the sensing parameter information in the first sensing configuration information. Optionally, if the second device sends the fifth information, it indicates that the second device does not support any of the sensing parameter information in the first sensing configuration information.

Optionally, in a case where the second device sends the fourth information, the first number of pieces of sensing parameter information in the first set include the one or more pieces of sensing parameter information. Optionally, in a case where the second device sends the fifth information, the first number of pieces of sensing parameter information in the first set does not include the one or more pieces of sensing parameter information, that is to say, the first number of pieces of sensing parameter information have no intersection with the one or more pieces of sensing parameter information. Optionally, in a case where the second device sends the fifth information, the first number of pieces of sensing parameter information in the first set includes part of the one or more pieces of sensing parameter information, that is to say, the first number of pieces of sensing parameter information are different from and have an intersection with the one or more pieces of sensing parameter information.

Optionally, the fourth information is used for indicating: first measurement values corresponding to at least part of the sensing parameter information in the first set are greater than or equal to a first threshold. Optionally, the fourth information is used for indicating: second measurement values corresponding to at least part of the sensing parameter information in the first set are smaller than or equal to a second threshold. Optionally, the fourth information is used for indicating: first measurement values corresponding to at least part of the sensing parameter information in the first set are greater than or equal to the first threshold, and second measurement values corresponding to at least part of the sensing parameter information in the first set are smaller than or equal to the second threshold.

Optionally, the fourth information is used for indicating at least one of: signal receiving powers corresponding to at least part of the sensing parameter information in the first set are greater than or equal to a first threshold corresponding to the signal receiving power; signal receiving qualities corresponding to at least part of the sensing parameter information in the first set are greater than or equal to a first threshold corresponding to the signal receiving quality; received signal strengths corresponding to at least part of the sensing parameter information in the first set are greater than or equal to a first threshold corresponding to the received signal strength; SINRs corresponding to at least part of the sensing parameter information in the first set are greater than or equal to a first threshold corresponding to the SINR; SNRs corresponding to at least part of the sensing parameter information in the first set are greater than or equal to a first threshold corresponding to the SNR; interference strengths corresponding to at least part of the sensing parameter information in the first set are smaller than or equal to a second threshold corresponding to the interference strength; noise strengths corresponding to at least part of the sensing parameter information in the first set are smaller than or equal to a second threshold corresponding to the noise strength; interference plus noise strengths corresponding to at least part of the sensing parameter information in the first set are smaller than or equal to a second threshold corresponding to the interference plus noise strength; interference powers corresponding to at least part of the sensing parameter information in the first set are smaller than or equal to a second threshold corresponding to the interference power; noise powers corresponding to at least part of the sensing parameter information in the first set are smaller than or equal to a second threshold corresponding to the noise power; or interference plus noise powers corresponding to at least part of the sensing parameter information in the first set are smaller than or equal to a second threshold corresponding to the interference plus noise power. The embodiments of the disclosure do not limit contents indicated by the fourth information, and the fourth information may indicate any one or more of the above-mentioned items. For example, the fourth information is used for indicating: signal receiving powers corresponding to at least part of the sensing parameter information in the first set are greater than or equal to the first threshold corresponding to the signal receiving power. For example, the fourth information is used for indicating: interference strengths corresponding to at least part of the sensing parameter information in the first set are smaller than or equal to the second threshold corresponding to the interference strength.

Optionally, the fifth information is used for indicating: first measurement values corresponding to all of the sensing parameter information in the first set are smaller than the first threshold. Optionally, the fifth information is used for indicating: second measurement values corresponding to all of the sensing parameter information in the first set are greater than the second threshold. Optionally, the fifth information is used for indicating: first measurement values corresponding to all of the sensing parameter information in the first set are smaller than the first threshold, and second measurement values corresponding to all of the sensing parameter information in the first set are greater than the second threshold.

Optionally, the fifth information is used for indicating at least one of: signal receiving powers corresponding to all of the sensing parameter information in the first set are smaller than a first threshold corresponding to the signal receiving power; signal receiving qualities corresponding to all of the sensing parameter information in the first set are smaller than a first threshold corresponding to the signal receiving quality; received signal strengths corresponding to all of the sensing parameter information in the first set are smaller than a first threshold corresponding to the received signal strength; SINRs corresponding to all of the sensing parameter information in the first set are smaller than a first threshold corresponding to the SINR; SNRs corresponding to all of the sensing parameter information in the first set are smaller than a first threshold corresponding to the SNR; interference strengths corresponding to all of the sensing parameter information in the first set are greater than a second threshold corresponding to the interference strength; noise strengths corresponding to all of the sensing parameter information in the first set are greater than a second threshold corresponding to the noise strength; interference plus noise strengths corresponding to all of the sensing parameter information in the first set are greater than a second threshold corresponding to the interference plus noise strength; interference powers corresponding to all of the sensing parameter information in the first set are greater than a second threshold corresponding to the interference power; noise powers corresponding to all of the sensing parameter information in the first set are greater than a second threshold corresponding to the noise power; or interference plus noise powers corresponding to all of the sensing parameter information in the first set are greater than a second threshold corresponding to the interference plus noise power. The embodiments of the disclosure do not limit contents indicated by the fifth information, and the fifth information may indicate any one or more of the above-mentioned items. For example, the fifth information is used for indicating: the signal receiving powers corresponding to all of the sensing parameter information in the first set are greater than or equal to the first threshold corresponding to the signal receiving power. For example, the fourth information is used for indicating: the interference strengths corresponding to all of the sensing parameter information in the first set are greater than the second threshold corresponding to the interference strength.

In some embodiments, on the first device side, the method further includes: in a case where the first device receives the fifth information, sending, by the first device, sixth information.

In some embodiments, on the second device side, the method further includes: in a case where the second device sends the fifth information, the second device receives the sixth information sent by the first device.

Optionally, the sixth information includes at least one of: second sensing configuration information, first measurement configuration information, identification information of the second device, reporting type configuration information of the first information, configuration information for a first window where the sensing signal is measured, configuration information for a second window where the first information is reported, configuration information for a third window where the sensing signal is measured and the first information is reported, or a number of pieces of sensing parameter information corresponding to the first information.

It is to be noted that the embodiments of the disclosure do not limit content included in the sixth information and specified in the protocols, and the sixth information may include any one or more of the above-mentioned items, and the sixth information may include all or a part of the above-mentioned items. For example, optionally, the sixth information may include the identification information of the second device, or may not include the identification information of the second device. For example, optionally, the sixth information may include the configuration information for the first window and the configuration information for the second window, and may not include the configuration information for the third window. For example, optionally, the sixth information may include the configuration information for the third window, but does not include the configuration information for the first window and the configuration information for the second window.

Optionally, the first device may unicast or multicast or broadcast the sixth information. Optionally, in a case where the first device unicasts the sixth information to the second device, the second device may measure the sensing signal and perform reporting according to the sixth information. For example, the second device may measure the sensing signal and perform reporting according to the configuration information of the second device and the received sixth information. Optionally, in a case where the first device unicasts the sixth information to the second device, the sixth information may or may not include identification information of the second device. Optionally, in a case where the first device multicasts or broadcasts the sixth information, one or more devices (including the second device) may measure the sensing signal and perform reporting according to the sixth information and their respective configuration information. For example, when the measurement parameters supported by the second device include signal receiving power, signal receiving quality, Doppler shift, angle parameter, and characteristic information of the sensed object, the second device performs measurement and reporting according to the measurement parameters supported by the second device; when the measurement parameters supported by the third device include interference strength, noise strength, and characteristic information of the sensed object, the third device performs measurement and reporting according to the measurement parameters supported by the third device. Optionally, in a case where the first device multicasts or broadcasts the sixth information to the second device, the sixth information may or may not include the identification information of the second device.

Optionally, in any of the embodiments of the disclosure, the identification information of the second device and/or the identification information of the first device described below may include at least one of the following the second device and/or the first device: a SUbscription Permanent Identifier (SUPI), a SUbscription Concealed Identifier (SUCI), a Generic Public Subscription Identifier (GPSI), an application layer ID, a Globally Unique Temporary Identity (GUTI), an International Mobile Equipment Identity (IMEI), an International Mobile Subscriber Identity (IMSI), an Temporary Mobile Subscriber Identity (TMSI), a Packet-Temporary Mobile Subscriber Identity (P-TMSI), a user mobile number, or the like.

Optionally, the second sensing configuration information includes a second set including a second number of pieces of sensing parameter information. Optionally, the second set is at least partially different from the first set. For example, the second set has no intersection with the first set. For another example, the second set is different from the first set but has an intersection with the first set.

Optionally, the second number of pieces of sensing parameter information include the one or more pieces of sensing parameter information. Optionally, the second number may be an integer greater than or equal to 1.

In some embodiments, the configuration information for event-triggered reporting includes at least one of:
a first threshold; or
a second threshold;
herein, at least one first measurement value in one-to-one correspondence with the at least one piece of sensing parameter information is greater than or equal to the first threshold;
at least one second measurement value in one-to-one correspondence with the at least one piece of sensing parameter information is smaller than or equal to a second threshold;
a first measurement value corresponding to current sensing parameter information is smaller than the first threshold;
a second measurement value corresponding to the current sensing parameter information is greater than the second threshold.

Optionally, at least one of the first measurement value or the second measurement value is included in the first measurement result.

Optionally, the first measurement value includes a measurement value of at least one of: signal receiving power, signal receiving quality, received signal strength, SINR, or SNR.

Optionally, the second measurement value includes a measurement value of at least one of: interference strength, noise strength, interference plus noise strength, interference power, noise power, or interference plus noise power.

Optionally, the configuration information for event-triggered reporting includes a first threshold and/or a second threshold. Optionally, the configuration information for event-triggered reporting indicates at least one of: at least one first measurement value in one-to-one correspondence with the at least one piece of sensing parameter information is greater than or equal to the first threshold; at least one second measurement value in one-to-one correspondence with the at least one piece of sensing parameter information is smaller than or equal to a second threshold; a first measurement value corresponding to current sensing parameter information is smaller than the first threshold; a second measurement value corresponding to the current sensing parameter information is greater than the second threshold.

Optionally, the configuration information for event-triggered reporting indicates at least one of: the signal receiving power in one-to-one correspondence with the at least one piece of sensing parameter information is greater than or equal to a first threshold corresponding to the signal receiving power; the signal receiving quality in one-to-one correspondence with the at least one piece of sensing parameter information is greater than or equal to a first threshold corresponding to the signal receiving quality; the received signal strength in one-to-one correspondence with the at least one piece of sensing parameter information is greater than or equal to a first threshold corresponding to the received signal strength; the SINR in one-to-one correspondence with the at least one piece of sensing parameter information is greater than or equal to a first threshold corresponding to the SINR; the SNR in one-to-one correspondence with the at least one piece of sensing parameter information is greater than or equal to a first threshold corresponding to the SNR; the interference strength in one-to-one correspondence with the at least one piece of sensing parameter information is smaller than or equal to a second threshold corresponding to the interference strength; the noise strength in one-to-one correspondence with the at least one piece of sensing parameter information is smaller than or equal to a second threshold corresponding to the noise strength; the interference plus noise strength in one-to-one correspondence with the at least one piece of sensing parameter information is smaller than or equal to a second threshold corresponding to the interference plus noise strength; the interference power in one-to-one correspondence with the at least one piece of sensing parameter information is smaller than or equal to a second threshold corresponding to the interference power; the noise power in one-to-one correspondence with the at least one piece of sensing parameter information is smaller than or equal to a second threshold corresponding to the noise power; or the interference plus noise power in one-to-one correspondence with the at least one piece of sensing parameter information is smaller than or equal to a second threshold corresponding to the interference plus noise power. The embodiments of the disclosure do not limit the contents indicated by the configuration information for event-triggered reporting, and the configuration information for event-triggered reporting may indicate any one or more of the above-mentioned items. For example, the at least one piece of sensing parameter information satisfies: the signal receiving power in one-to-one correspondence with the at least one piece of sensing parameter information is greater than or equal to the first threshold corresponding to the signal receiving power. For example, the at least one piece of sensing parameter information satisfies: at least one interference strength in one-to-one correspondence with the at least one piece of sensing parameter information is smaller than or equal to the second threshold corresponding to the interference strength.

Optionally, the configuration information for event-triggered reporting indicates at least one of: a signal receiving power corresponding to current sensing parameter information is smaller than a first threshold corresponding to the signal receiving power; a signal receiving quality corresponding to current sensing parameter information is smaller than a first threshold corresponding to the signal receiving quality; a received signal strength corresponding to current sensing parameter information is smaller than a first threshold corresponding to the received signal strength; an SINR corresponding to current sensing parameter information is smaller than a first threshold corresponding to the SINR; an SNR corresponding to current sensing parameter information is smaller than a first threshold corresponding to the SNR; an interference strength corresponding to current sensing parameter information is greater than a second threshold corresponding to the interference strength; a noise strength corresponding to current sensing parameter information is greater than a second threshold corresponding to the noise strength; an interference plus noise strength corresponding to current sensing parameter information is greater than a second threshold corresponding to the interference plus noise strength; an interference power corresponding to current sensing parameter information is greater than a second threshold corresponding to the interference power; a noise power corresponding to current sensing parameter information is greater than a second threshold corresponding to the noise power; or an interference plus noise power corresponding to current sensing parameter information is greater than an interference plus noise power corresponding to the interference strength. The embodiments of the disclosure do not limit the contents indicated by the configuration information for event-triggered reporting, and the configuration information for event-triggered reporting may indicate any one or more of the above-mentioned items. For example, the configuration information for event-triggered reporting indicates: the signal receiving power corresponding to current sensing parameter information is smaller than the first threshold corresponding to the signal receiving power. For example, the configuration information for event-triggered reporting indicates: the interference strength corresponding to current sensing parameter information is greater than the second threshold corresponding to the interference strength.

In some embodiments, on the first device side, the method further includes: sending, by the first device, a first request.

In some embodiments, on the second device side, the method further includes: receiving, by the second device, the first request sent by the first device.

Optionally, the first request includes at least one of: identification information of the first device, or second measurement configuration information.

Optionally, the second measurement configuration information includes at least one of: signal receiving power, signal receiving quality, received signal strength, SINR, SNR, interference strength, noise strength, interference plus noise strength, interference power, noise power, interference plus noise power, Doppler shift, angle parameter, or characteristic information of a sensed object.

Optionally, the first device may unicast or multicast or broadcast the first request. For example, the first device may unicast the first request to the second device to cause the second device to send the fifth information to the first device. For another example, the first device may multicast or broadcast the first request, so that each of the at least one device (including the second device) receiving the first request sends the fifth information to the first device, and the contents in the fifth information sent by different devices may be the same or different. For another example, the first device sends the first request, and at least one device (including the second device) receiving the first request does not send the fifth information to the first device, but receives first configuration information sent by the first device, in a case where measurements of at least part of parameters in the second measurement configuration information are supported.

Optionally, the first request may be used for requesting the device receiving the first request to perform measurement of the sensing signal. Optionally, the first request may include identification information of the first device. Optionally, the first request may include the second measurement configuration information. Optionally, the first request may include the identification information of the first device and the second measurement configuration information.

Optionally, the second measurement configuration information may include measurement parameter information that needs to be measured by at least one device (including the second device) receiving the first request.

Optionally, the second measurement configuration information may include the above-mentioned first measurement configuration information. For example, the measurement parameter information included in the second measurement configuration information is the same as the measurement parameter information included in the first measurement configuration information, or the second measurement configuration information is the same as the first measurement configuration information. For another example, the first measurement configuration information may be a subset of the second measurement configuration information. For example, the second measurement configuration information includes: signal receiving power, signal receiving quality, received signal strength, SINR, SNR, interference strength, noise strength, interference plus noise strength, interference power, noise power, interference plus noise power, Doppler shift, angle parameter, and characteristic information of a sensed object; whereas the first measurement configuration information includes: signal receiving power, signal receiving quality, received signal strength, SNR, interference strength, noise strength, Doppler shift, angle parameter, and characteristic information of a sensed object. The embodiments of the disclosure do not limit the specific contents included in the second measurement configuration information, and the contents included in the second measurement configuration information may be any one or more of the above-mentioned items.

In some embodiments, on the first device side, the method further includes: receiving, by the first device, seventh information sent by the second device.

In some embodiments, on the second device side, the method further includes: sending, by the second device, the seventh information to the first device.

Optionally, the seventh information includes at least one of: identification information of the second device, third measurement configuration information supported by the second device, or a third set supported by the second device, the third set including a third number of pieces of sensing parameter information.

Optionally, the third measurement configuration information includes at least one of: signal receiving power, signal receiving quality, received signal strength, SINR, SNR, interference strength, noise strength, interference plus noise strength, interference power, noise power, interference plus noise power, Doppler shift, angle parameter, or characteristic information of a sensed object.

Optionally, the third number of pieces of sensing parameter information include the one or more pieces of sensing parameter information. Optionally, the third number may be an integer greater than or equal to 1.

Optionally, each of the at least one device (including the second device) may send the seventh information to the first device, and the contents included in the seventh information sent by different devices may be the same or different. For example, the third measurement configuration information supported by the second device may be the same as or different from measurement configuration information supported by another device (e.g., the third device) of the at least one device. For example, a third number of pieces of sensing parameter information included in a third set supported by the second device may be the same as or different from a fourth number of pieces of sensing parameter information included in the fourth set supported by another device (e.g., the third device) of the at least one device. Optionally, the fourth number may be an integer greater than or equal to 1.

Optionally, the seventh information sent by the second device may be used for indicating that the second device supports measurement of the sensing signal.

Optionally, the seventh information sent by the second device may include an identifier of the second device. Optionally, the seventh information sent by the second device may include the third measurement configuration information supported by the second device. Optionally, the seventh information sent by the second device may include the third set supported by the second device.

Optionally, the third measurement configuration information supported by the second device may be included in the second measurement configuration information. For example, the third measurement configuration information supported by the second device may be the same as the second measurement configuration information. For another example, the third measurement configuration information supported by the second device may be a subset of the second measurement configuration information.

Optionally, the third measurement configuration information supported by the second device may be included in the first measurement configuration information. For example, the third measurement configuration information supported by the second device may be the same as the first measurement configuration information. For another example, the third measurement configuration information supported by the second device may be a subset of the first measurement configuration information.

Optionally, the first measurement configuration information may be included in the third measurement configuration information supported by the second device. For example, the third measurement configuration information supported by the second device may be the same as the second measurement configuration information. For another example, the second measurement configuration information may be a subset of the third measurement configuration information supported by the second device.

In some embodiments, in any of the embodiments of the disclosure, the sensing parameter information includes a frequency; the first sensing parameter information includes a first frequency; and the second sensing parameter information includes a second frequency.

The communication method according to the embodiment of the disclosure will be described below by taking the sensing parameter information including the frequency as an example.

In some embodiments, the communication method includes: a first device receives first information sent by a second device; the first information is determined according to one or more first measurement results, the one or more first measurement results being determined respectively by measuring a sensing signal according to one or more frequencies, where the first information includes a first frequency. Or, the method further includes: the first device sends second information including the first frequency.

In some embodiments, the method further includes:
the first device receives a second measurement result sent by the second device, where the second measurement result is a measurement result obtained by measuring the sensing signal according to the first frequency, and the second measurement result is used for determining a sensing result of a sensed object; or,
the first device receives the sensing result of the sensed object sent by the second device, where the sensing result of the sensed object is determined according to the second measurement result, the second measurement result being a measurement result obtained by measuring the sensing signal according to the first frequency; or,
the first device receives a first processing result sent by the second device, where the first processing result is used for determining the sensing result of the sensed object, and the first processing result is obtained by processing the second measurement result, the second measurement result being a measurement result obtained by measuring the sensing signal according to the first frequency.

In some embodiments, the second information further includes one or more second frequencies; the one or more second frequencies are used by the second device for switching from measuring the sensing signal according to the first frequency to measuring the sensing signal according to a specific frequency, the specific frequency being included in the one or more second frequencies.

In some embodiments, the first information includes at least one of: at least one frequency, where the at least one frequency is included in the one or more frequencies, and the at least one frequency is determined according to the one or more first measurement results; at least one first measurement result obtained respectively by measuring the sensing signal according to the at least one frequency; or the one or more first measurement results.

Optionally, the at least one frequency satisfies at least one of: at least one first measurement value in one-to-one correspondence with the at least one frequency is greater than or equal to a first threshold; or at least one second measurement value in one-to-one correspondence with the at least one frequency is smaller than or equal to a second threshold.

In some embodiments, the third information includes at least one of: first sensing configuration information that includes a first set including a first number of frequencies, first measurement configuration information, identification information of the second device, reporting type configuration information of the first information, configuration information for a first window where the sensing signal is measured, configuration information for a second window where the first information is reported, configuration information for a third window where the sensing signal is measured and the first information is reported, or a number of frequencies corresponding to the first information.

In some embodiments, the communication method further includes: the second device sends fourth information or fifth information to the first device; and the first device receives the fourth information or fifth information sent by the second device. Optionally, the fourth information is used for indicating at least one of: first measurement values corresponding to at least part of frequencies in the first set are greater than or equal to the first threshold, or second measurement values corresponding to at least part of the frequencies in the first set are smaller than or equal to the second threshold. Optionally, the fifth information is used for indicating at least one of: first measurement values corresponding to all of the frequencies in the first set are smaller than the first threshold, or second measurement values corresponding to all of the frequencies in the first set are greater than the second threshold.

In some embodiments, the method further includes: in a case where the first device receives the fifth information, the first device sends sixth information, and the second device receives the sixth information sent by the first device. Optionally, the sixth information includes at least one of: second sensing configuration information that includes a second set including a second number of frequencies, where the second set is at least partially different from the first set; first measurement configuration information; identification information of the second device; reporting type configuration information of the first information; configuration information for a first window where the sensing signal is measured; configuration information for a second window where the first information is reported; configuration information for a third window where the sensing signal is measured and the first information is reported; or a number of frequencies corresponding to the first information.

Optionally, the configuration information for event-triggered reporting includes at least one of: a first threshold, or a second threshold, where at least one first measurement value in one-to-one correspondence with the at least one frequency is greater than or equal to the first threshold; at least one second measurement value in one-to-one correspondence with the at least one frequency is smaller than or equal to a second threshold; a first measurement value corresponding to a current frequency is smaller than the first threshold; a second measurement value corresponding to the current frequency is greater than the second threshold.

In some embodiments, the communication method further includes: the second device sends seventh information to the first device; and the first device receives the seventh information sent by the second device. Optionally, the seventh information includes at least one of: identification information of the second device, third measurement configuration information supported by the second device, or a third set supported by the second device, the third set including a third number of frequencies.

It should be noted that, some embodiments of the communication method of the disclosure are described herein by taking the sensing parameter information being frequency as example, and parts not described herein can be understood with reference to the description of the sensing parameter information, which will not be repeated.

In some embodiments, in any of the embodiments of the disclosure, the sensing parameter information includes a spatial filter; the first sensing parameter information includes a first spatial filter; and the second sensing parameter information includes a second spatial filter.

Optionally, in any of the embodiments of the disclosure, the spatial filter may include a spatial transmission filter, or a spatial sending filter, or a spatial receiving filter, or a beam.

The communication method according to the embodiment of the disclosure will be described below by taking the sensing parameter information including the spatial filter as an example.

In some embodiments, the communication method includes: a first device receives first information sent by a second device; the first information is determined according to one or more first measurement results, the one or more first measurement results being determined respectively by measuring a sensing signal according to one or more spatial filters, where the first information includes a first spatial filter. Or, the method further includes: the first device sends second information including the first spatial filter.

In some embodiments, the method further includes:
the first device receives a second measurement result sent by the second device, where the second measurement result is a measurement result obtained by measuring the sensing signal according to the first spatial filter, and the second measurement result is used for determining a sensing result of a sensed object; or,
the first device receives the sensing result of the sensed object sent by the second device, where the sensing result of the sensed object is determined according to the second measurement result, the second measurement result being a measurement result obtained by measuring the sensing signal according to the first spatial filter; or,
the first device receives a first processing result sent by the second device, where the first processing result is used for determining the sensing result of the sensed object, and the first processing result is obtained by processing the second measurement result, the second measurement result being a measurement result obtained by measuring the sensing signal according to the first spatial filter.

In some embodiments, the second information further includes one or more second spatial filters; the one or more second spatial filters are used by the second device for switching from measuring the sensing signal according to the first spatial filter to measuring the sensing signal according to a specific spatial filter, the specific spatial filter being included in the one or more second spatial filters.

In some embodiments, the first information includes at least one of: at least one spatial filters, where the at least one spatial filter is included in the one or more spatial filters, and the at least one spatial filter is determined according to the one or more first measurement results; at least one first measurement result obtained respectively by measuring the sensing signal according to the at least one spatial filter; or the one or more first measurement results.

Optionally, the at least one spatial filter satisfies at least one of: at least one first measurement value in one-to-one correspondence with the at least one spatial filter is greater than or equal to a first threshold; or at least one second measurement value in one-to-one correspondence with the at least one spatial filter is smaller than or equal to a second threshold.

In some embodiments, the third information includes at least one of: first sensing configuration information that includes a first set including a first number of spatial filters, first measurement configuration information, identification information of the second device, reporting type configuration information of the first information, configuration information for a first window where the sensing signal is measured, configuration information for a second window where the first information is reported, configuration information for a third window where the sensing signal is measured and the first information is reported, or a number of spatial filters corresponding to the first information.

In some embodiments, the communication method further includes: the second device sends fourth information or fifth information to the first device; and the first device receives the fourth information or fifth information sent by the second device. Optionally, the fourth information is used for indicating at least one of: first measurement values corresponding to at least part of spatial filters in the first set are greater than or equal to the first threshold, or second measurement values corresponding to at least part of the spatial filters in the first set are smaller than or equal to the second threshold. Optionally, the fifth information is used for indicating at least one of: first measurement values corresponding to all of the spatial filters in the first set are smaller than the first threshold, or second measurement values corresponding to all of the spatial filters in the first set are greater than the second threshold.

In some embodiments, the method further includes: in a case where the first device receives the fifth information, the first device sends sixth information, and the second device receives the sixth information sent by the first device. Optionally, the sixth information includes at least one of: second sensing configuration information that includes a second set including a second number of spatial filters, where the second set is at least partially different from the first set; first measurement configuration information; identification information of the second device; reporting type configuration information of the first information; configuration information for a first window where the sensing signal is measured; configuration information for a second window where the first information is reported; configuration information for a third window where the sensing signal is measured and the first information is reported; or a number of spatial filters corresponding to the first information.

Optionally, the configuration information for event-triggered reporting includes at least one of: a first threshold, or a second threshold, where at least one first measurement value in one-to-one correspondence with the at least one spatial filter is greater than or equal to the first threshold; at least one second measurement value in one-to-one correspondence with the at least one spatial filter is smaller than or equal to a second threshold; a first measurement value corresponding to a current spatial filter is smaller than the first threshold; a second measurement value corresponding to the current spatial filter is greater than the second threshold.

In some embodiments, the communication method further includes: the second device sends seventh information to the first device; and the first device receives the seventh information sent by the second device. Optionally, the seventh information includes at least one of: identification information of the second device, third measurement configuration information supported by the second device, or a third set supported by the second device, the third set including a third number of spatial filters.

It should be noted that, some embodiments of the communication method of the disclosure are described herein by taking the sensing parameter information being spatial filter as example, and parts not described herein can be understood with reference to the description of the sensing parameter information, which will not be repeated.

In some embodiments, in any of the embodiments of the disclosure, the sensing parameter information includes a parameter combination including a combination of frequency and spatial filter, and the first sensing parameter information includes a first parameter combination including a combination of a first set of frequencies and a first set of spatial filters, and the second sensing parameter information includes a second parameter combination including a combination of a second set of frequencies and a second set of spatial filters.

Optionally, the first parameter combination and/or the second parameter combination may be any one of one or more parameter combinations, and the first parameter combination and/or the second parameter combination do not constitute a limitation of the order. Optionally, different parameter combinations may have part of their parameters same with each other, or different parameter combinations have parameters different from each other. For example, the first set of frequencies are different from the second set of frequencies, and the first set of spatial filters are the same as the second set of spatial filters. For another example, the first set of frequencies are the same as the second set of frequencies, and the first set of spatial filters are different from the second set of spatial filters. For another example, the first set of frequencies are different from the second set of frequencies, and the first set of spatial filters are different from the second set of spatial filters.

The communication method according to the embodiment of the disclosure will be described below by taking the sensing parameter information including the parameter combination as an example.

In some embodiments, the communication method includes: a first device receives first information sent by a second device; the first information is determined according to one or more first measurement results, the one or more first measurement results being determined respectively by measuring a sensing signal according to one or more parameter combinations, where the first information includes a first parameter combination. Or, the method further includes: the first device sends second information including the first parameter combination.

In some embodiments, the method further includes:
the first device receives a second measurement result sent by the second device, where the second measurement result is a measurement result obtained by measuring the sensing signal according to the first parameter combination, and the second measurement result is used for determining a sensing result of a sensed object; or,
the first device receives the sensing result of the sensed object sent by the second device, where the sensing result of the sensed object is determined according to the second measurement result, the second measurement result being a measurement result obtained by measuring the sensing signal according to the first parameter combination; or,
the first device receives a first processing result sent by the second device, where the first processing result is used for determining the sensing result of the sensed object, and the first processing result is obtained by processing the second measurement result, the second measurement result being a measurement result obtained by measuring the sensing signal according to the first parameter combination.

In some embodiments, the second information further includes one or more second parameter combinations; the one or more second parameter combinations are used by the second device for switching from measuring the sensing signal according to the first parameter combination to measuring the sensing signal according to a specific parameter combination, the specific parameter combination being included in the one or more second parameter combinations.

In some embodiments, the first information includes at least one of: at least one parameter combination, where the at least one parameter combination is included in the one or more parameter combinations, and the at least one parameter combination is determined according to the one or more first measurement results; at least one first measurement result obtained respectively by measuring the sensing signal according to the at least one parameter combination; or the one or more first measurement results.

Optionally, the at least one parameter combination satisfies at least one of: at least one first measurement value in one-to-one correspondence with the at least one parameter combination is greater than or equal to a first threshold; or at least one second measurement value in one-to-one correspondence with the at least one parameter combination is smaller than or equal to a second threshold.

In some embodiments, the third information includes at least one of: first sensing configuration information that includes a first set including a first number of parameter combinations, first measurement configuration information, identification information of the second device, reporting type configuration information of the first information, configuration information for a first window where the sensing signal is measured, configuration information for a second window where the first information is reported, configuration information for a third window where the sensing signal is measured and the first information is reported, or a number of parameter combinations corresponding to the first information.

In some embodiments, the communication method further includes: the second device sends fourth information or fifth information to the first device; and the first device receives the fourth information or fifth information sent by the second device. Optionally, the fourth information is used for indicating at least one of: first measurement values corresponding to at least part of parameter combinations in the first set are greater than or equal to the first threshold, or second measurement values corresponding to at least part of the parameter combinations in the first set are smaller than or equal to the second threshold.

Optionally, the fifth information is used for indicating at least one of: first measurement values corresponding to all of the parameter combinations in the first set are smaller than the first threshold, or second measurement values corresponding to all of the parameter combinations in the first set are greater than the second threshold.

In some embodiments, the method further includes: in a case where the first device receives the fifth information, the first device sends sixth information, and the second device receives the sixth information sent by the first device. Optionally, the sixth information includes at least one of: second sensing configuration information that includes a second set including a second number of parameter combinations, where the second set is at least partially different from the first set; first measurement configuration information; identification information of the second device; reporting type configuration information of the first information; configuration information for a first window where the sensing signal is measured; configuration information for a second window where the first information is reported; configuration information for a third window where the sensing signal is measured and the first information is reported; or a number of parameter combinations corresponding to the first information.

Optionally, the configuration information for event-triggered reporting includes at least one of: a first threshold, or a second threshold, where at least one first measurement value in one-to-one correspondence with the at least one parameter combination is greater than or equal to the first threshold; at least one second measurement value in one-to-one correspondence with the at least one parameter combination is smaller than or equal to a second threshold; a first measurement value corresponding to a current parameter combination is smaller than the first threshold; a second measurement value corresponding to the current parameter combination is greater than the second threshold.

In some embodiments, the communication method further includes: the second device sends seventh information to the first device; and the first device receives the seventh information sent by the second device. Optionally, the seventh information includes at least one of: identification information of the second device, third measurement configuration information supported by the second device, or a third set supported by the second device, the third set including a third number of parameter combinations.

It should be noted that, some embodiments of the communication method of the disclosure are described herein by taking the sensing parameter information being parameter combination as example, and parts not described herein can be understood with reference to the description of the sensing parameter information, which will not be repeated.

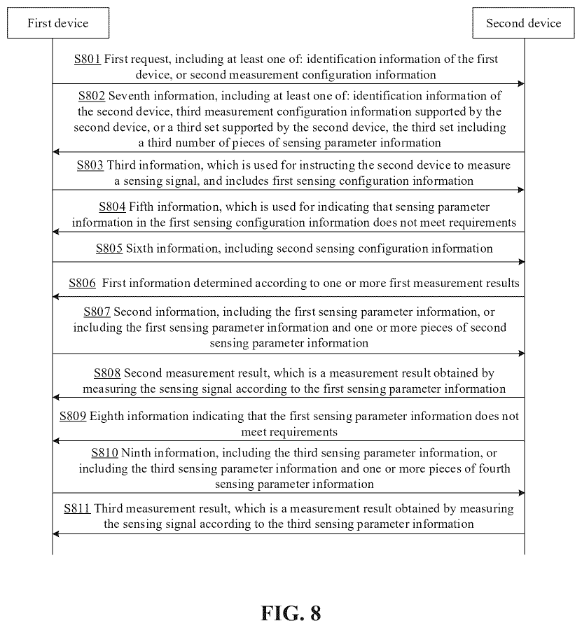

FIG. 8 is a schematic flowchart of still another communication method according to an embodiment of the disclosure. As shown in FIG. 8, the method includes operations S801 to S811.

In S801, a first device sends a first request, where the first request includes at least one of: identification information of the first device, or second measurement configuration information.

In S802, a second device sends seventh information to the first device, where the seventh information includes at least one of: identification information of the second device, third measurement configuration information supported by the second device, or a third set supported by the second device, the third set including a third number of pieces of sensing parameter information.

In S803, the first device sends third information, where the third information is used for instructing the second device to measure the sensing signal, and includes first sensing configuration information.

It should be noted that the embodiment of the disclosure provides an implementation in which the third information includes the first sensing configuration information, and in other embodiments, the third information may not include the first sensing configuration information.

In S804, the second device sends fifth information to the first device, where the fifth information is used for indicating that sensing parameter information in the first sensing configuration information does not meet requirements.

Optionally, the fact that the sensing parameter information in the first sensing configuration information does not meet requirements may include at least one of: first measurement values corresponding to all of the sensing parameter information in the first set are smaller than the first threshold, or second measurement values corresponding to all of the sensing parameter information in the first set are greater than the second threshold.

In S805, the first device sends sixth information including second sensing configuration information.

In S806, the second device sends first information to the first device, where the first information is determined according to one or more first measurement results.

In S807, the first device sends second information, where the second information includes the first sensing parameter information, or the second information includes the first sensing parameter information and one or more pieces of second sensing parameter information.

It should be noted that the embodiment of the disclosure provides an implementation in which the first device sends the first sensing parameter information to the second device, and in other embodiments, it may be that the first information sent by the second device to the first device may include the first sensing parameter information.

In S808, the second device sends a second measurement result to the first device, where the second measurement result is a measurement result obtained by measuring the sensing signal according to the first sensing parameter information.

Optionally, the first device may determine characteristic information of the sensed object according to the second measurement result.

Optionally, the second measurement result may be sent periodically, or may be reported in an event-triggered manner.

It should be noted that the embodiment of the disclosure provide an implementation in which the second device sends the second measurement result to the first device, and in other embodiments, the second device may send, to the first device, a sensing result of the sensed object or the first processing result.

In S809, in a case where the first sensing parameter information does not meet the requirements, the second device sends eighth information to the first device, where the eighth information indicates that the first sensing parameter information does not meet requirements.

Optionally, the fact that the first sensing parameter information does not meet requirements may include at least one of: a first measurement value corresponding to the first sensing parameter information is smaller than the first threshold; the second measurement value corresponding to the first sensing parameter information is greater than the second threshold; a first measurement value corresponding to third sensing parameter information is greater than or equal to the first threshold; or a second measurement value corresponding to the third sensing parameter information is smaller than or equal to the second threshold.

Optionally, the eighth information may include at least one of: a first measurement result corresponding to each of the first sensing parameter information and/or the one or more pieces of second sensing parameter information, a part (including the third sensing parameter information) of the one or more pieces of second sensing parameter information, or first measurement result(s) corresponding to the part of the one or more pieces of second sensing parameter information. Optionally, the first measurement value(s) corresponding to the part of the one or more pieces of second sensing parameter information is/are greater than or equal to the first threshold, and/or second measurement value(s) corresponding to the part of the one or more pieces of second sensing parameter information is/are smaller than or equal to the second threshold.

In S810, the first device sends ninth information, where the ninth information includes the third sensing parameter information, or the ninth information includes the third sensing parameter information and one or more pieces of fourth sensing parameter information.

Optionally, the determination manner of the third sensing parameter information is similar to the determination manner of the first sensing parameter information. Optionally, the determination manner of the one or more pieces of fourth sensing parameter information is similar to the determination manner of the one or more pieces of second sensing parameter information.

In S811, the second device sends a third measurement result to the first device, where the third measurement result is a measurement result obtained by measuring the sensing signal according to the third sensing parameter information.

Optionally, the first device may determine characteristic information of the sensed object according to the third measurement result.

Optionally, the third measurement result may be sent periodically, or may be reported in an event-triggered manner.

It should be noted that the embodiment of the disclosure provide an implementation in which the second device sends the third measurement result to the first device, and in other embodiments, the second device may send, to the first device, a sensing result of the sensed object or the second processing result.

It should be noted that in the embodiment corresponding to FIG. 8, the first device and the second device may select and perform one or more operations in the embodiment corresponding to FIG. 8, and the embodiment of the disclosure does not limit which operations the first device and the second device specifically perform. For example, in some embodiments, operations S804 and S805 may not be performed. For example, in some embodiments, operations S809 to S811 may not be performed. For example, in some embodiments, operations S801 and/or S802 may not be performed.

It is to be noted that in the embodiment corresponding to FIG. 8, the second device reports the second measurement result and the third measurement result to the first device, so that the first device determines the characteristic information of the sensed object according to the second measurement result and the third measurement result. In another embodiment, the second device may directly determine the characteristic information of the sensed object according to the second measurement result and the third measurement result, and send the characteristic information of the sensed object to the first device.

Several embodiments of the communication method of the disclosure will be described below.

### Embodiment 1: ISAC and Interference Avoidance Based on Frequency Switching

In the Integrated Sensing and Communication (hereinafter referred to as ISAC), the ideal way is to implement the detection and analysis of objects with the help of capabilities of existing communication systems. However, sensing usually requires a relatively high SNR of the signal. In an environment with strong interference, the sensing capability of the communication will be greatly reduced, making it difficult to accurately sense the surrounding environment. The following will take the ISAC between terminal devices as an example to introduce the composition of the ISAC and how to avoid interference based on frequency switching.

Terminal devices usually support many working frequencies to meet different network deployment requirements and/or roaming requirements. For different scenarios, the type and/or intensity of interference are also different, and the interference is often related to the surrounding terminal devices. If a terminal device performing detection is relatively close to other communication terminal devices and has the same frequency as the terminal devices, there will be relatively strong interference; and otherwise, the interference will be weak. This situation changes dynamically. Therefore, the interference situation and sensing accuracy at the same time and/or at different operating frequencies will also change dynamically. In order to avoid interference, dynamic frequency selection is a possible solution.

FIG. 9 is a schematic diagram showing an ISAC scenario between terminal devices according to an embodiment of the disclosure. As shown in FIG. 9, a terminal device 1 (corresponding to the above-described first device) is a sensing control terminal device, a terminal device 2 (corresponding to the above-described second device) is a sensing assistance terminal device, other terminal devices are communication terminal devices that do not participate in the ISAC, and the sensing signal is measured and reported between the terminal device 1 and the terminal device 2. Here, there may be a detection target (i.e., a sensed object) between the sensing control terminal device 1 and the sensing assistance terminal device 2.

The selection of the control terminal device and the sensing assistance terminal device will be described below.

The sensing control terminal device 1 needs to select a sensing assistance terminal device to form a sensing terminal device combination. In order to achieve this purpose, the terminal device 1 needs to send a sensing assistance request (corresponding to the first request described above) to its peripheral terminal devices before performing the ISAC.

Information of the request includes at least one of: an identifier of the sensing control terminal device, or a sensing measurement target parameter (such as at least one of: receiving power, noise strength, SNR, Doppler shift, angle parameter, etc.).

Optionally, after receiving the sensing assistance request from the terminal device 1, the terminal device 2 and the terminal device 3 (corresponding to the third device described above) may send a sensing assistance response message (corresponding to the fifth information described above) to the terminal device 1 if the devices satisfy at least a part of the measurement target parameter capability of the terminal device 1.

Optionally, the assistance response message includes at least one of: an identifier of the terminal device, supported sensing measurement target parameter, information of supported frequencies, or the like.

Optionally, after receiving the sensing assistance response message from the terminal device 2 and/or the terminal device 3, the terminal device 1 may adopt two way.

In a first way, the terminal device 1 further confirms which terminal device is needed to assist the terminal device 1 in performing the ISAC. Here, there may be one terminal device or a plurality of terminal devices used for sensing assistance. After the terminal device 1 determines terminal devices to be used for sensing assistance, the terminal device 1 and these determined terminal devices will form a terminal device combination for ISAC. For example, the terminal device that assists in sensing may be the terminal device 2.

In a second way, it is not necessary to determine terminal devices to be used for sensing assistance, that is to say, the sensing control terminal device 1 will then directly send a sensing signal, a control signal, or the like according to the received sensing assistance response message. The terminal device receiving the sensing signal or the control signal sent by the terminal device 1 performs measurement, feedback and the like according to the requirements of the terminal device 1.

The following describes the configuration related to sensing measurement.

The configuration related to sensing measurement mainly includes at least one of the following contents: configuration for target frequency, measurement quantity for sensing, reporting of sensing measurement result, or the like.

### Configuration of Target Frequencies for Sensing:

In a scenario where there is a terminal device combination for ISAC (i.e., the first way above), the sensing control terminal device 1 selects and configures some candidate frequencies f1, f2, . . . fn for sensing according to the frequency capability supported by the sensing assistance terminal device 2. The terminal device 2 performs measurements at these frequencies in accordance with the configuration of the measurement quantity for sensing.

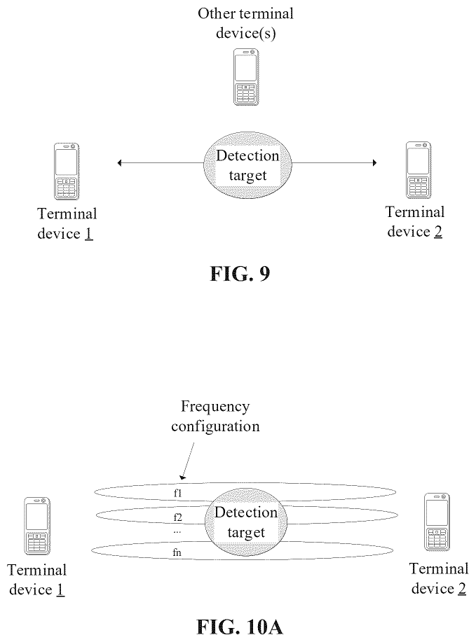

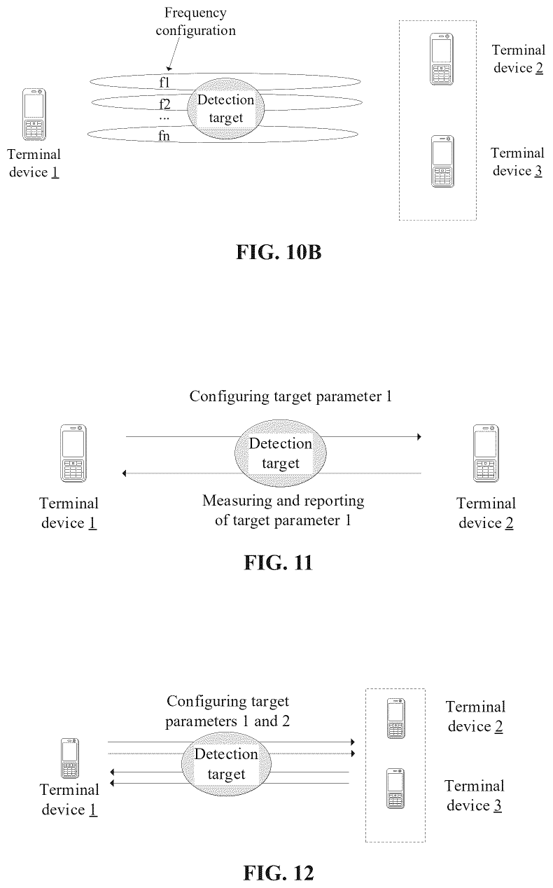

FIG. 10A is a schematic diagram showing frequency configuration according to an embodiment of the disclosure. As shown in FIG. 10A, the sensing control terminal device 1 configures f1, f2, . . . fn (corresponding to the first number of frequencies described above) to the sensing assistance terminal device 2, and the sensing assistance terminal device 2 measures the sensing signal at f1, f2, . . . fn. Here, there may be a detection target (i.e., a sensed object) between the sensing control terminal device 1 and the sensing assistance terminal device 2.

In a scenario where there is not a terminal device combination for ISAC (i.e., the second way above), the sensing control terminal device 1 selects and configures some candidate frequencies f1, f2, . . . , fn for sensing according to the frequency capability included in the received sensing assistance response message. The terminal device having the sensing assistance capability can measure at these frequencies according to the configuration of the measurement quantity for sensing.

FIG. 10B is a schematic diagram showing another frequency configuration according to an embodiment of the disclosure. As shown in FIG. 10B, the sensing control terminal device 1 configures f1, f2, . . . fn (corresponding to the first number of frequencies described above) to the sensing assistance terminal device 2; and the sensing assistance terminal device 2 determines its supported frequency from the group of f1, f2, . . . fn, and measures the sensing signal at the supported frequency, and the sensing assistance terminal device 3 determines its supported frequency from the group of f1, f2, . . . fn, and measures the sensing signal at the supported frequency. Herein, there may be a detection target (i.e. a sensed object) between the sensing control terminal device 1 and the sensing assistance terminal devices 2 and 3.

### Configuration of Sensing Measurement Parameters:

As described above, the target sensing measurement parameter(s) may include one or more parameters, such as at least one of: receiving power, noise strength, SNR, Doppler shift, angle parameter, etc. One sensing assistance terminal device may not be able to support all of the measurement parameters, and the supported measurement parameters may be notified to the sensing control terminal device 1 through the aforementioned sensing assistance response message. The sensing control terminal device further configures corresponding target measurement parameter(s) according to the capabilities of each sensing assistance terminal device.

FIG. 11 is a schematic diagram showing measurement parameter configuration according to an embodiment of the disclosure. As shown in FIG. 11, in a scenario where there is a terminal device combination for ISAC (i.e., the first way above), the sensing measurement parameter (corresponding to the above-described first measurement configuration information) is configured by selecting all or part of the parameters supported by the terminal device (herein, parameter 1 is configured). The configuration information includes the target terminal device. For example, the sensing assistance terminal device 2 measures the target parameter 1 and reports to the sensing control terminal device 1, and the sensing control terminal device 1 configures the target parameter 1 to the sensing assistance terminal device 2. Here, there may be a detection target (i.e., a sensed object) between the sensing control terminal device 1 and the sensing assistance terminal device 2.

FIG. 12 is a schematic diagram showing measurement parameter configuration according to an embodiment of the disclosure. As shown in FIG. 12, in a scenario where there is not a terminal device combination for ISAC (i.e., the second way above), the sensing measurement parameter is configured by selecting all or part of the parameters supported by the terminal device (herein, parameters 1 and 2 are configured), which are included in the sensing assistance response message. The configuration information does not contain the target terminal device, and the receiving terminal device itself determines which target parameter to measure and report. For example, the sensing assistance terminal device 2 measures the target parameter and reports to the sensing control terminal device, and the sensing control terminal device 1 configures the target parameters 1 and 2. Herein, there may be a detection target (i.e. a sensed object) between the sensing control terminal device 1 and the sensing assistance terminal devices 2 and 3.

### Configuration of Reporting Conditions for Sensing Measurement Results:

The sensing control terminal device analyzes a distance, a moving direction, and the like of the detection target based on a measurement result (such as information of at least one of power, angle, speed, and the like) of the sensing assistance terminal device. In order to avoid interference, the sensing control terminal device needs to determine an interference status for a target frequency based on the measurement results of the interference strength, the SNR and the like of the sensing assistance terminal device at the target frequency.

As to the configuration of reporting conditions for sensing measurement results (including the measurement results required for analyzing the detection target and some interference measurement results required for avoiding interference described above), the sensing control terminal device 1 may configure the sensing assistance terminal device 2 to perform periodic measurement or event-triggered measurement at these target frequencies.

The trigger event for reporting the interference measurement may be: an SNR or downlink signal strength of the frequency for ISAC is lower than a certain threshold, or the interference strength is higher than a certain threshold. When these trigger events occur, it means that the current frequency for ISAC can no longer meet the requirements of the ISAC, and the frequency needs to be switched; or, the SNR or downlink signal strength of other candidate frequencies for ISAC is higher than a certain threshold (or higher than the current frequency for ISAC by a certain threshold). When these trigger events occur, it represents that a candidate frequency for ISAC is a more suitable frequency for ISAC.

### Configuration of a Window for Reporting Sensing Measurement Result(s)

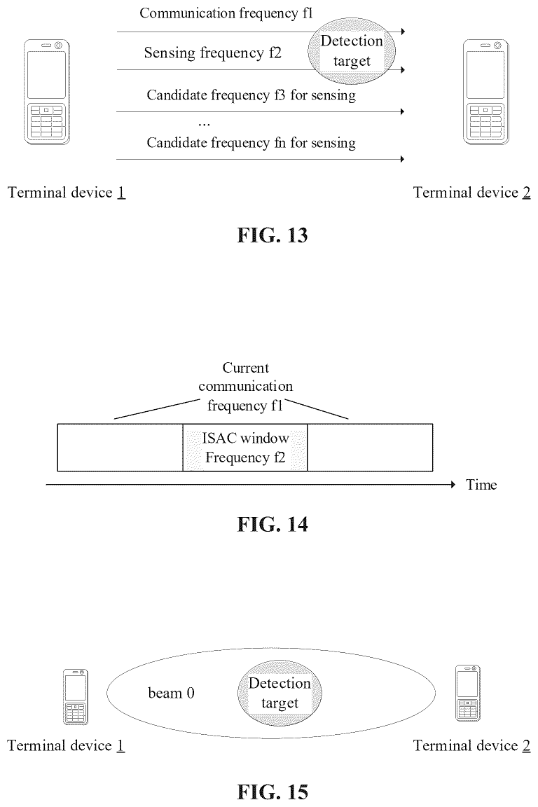

FIG. 13 is a schematic diagram showing a sensing frequency different from a communication frequency according to an embodiment of the disclosure. As shown in FIG. 13, when a communication frequency of the sensing control terminal device and the sensing assistance terminal device is different from the target frequency for sensing, as shown in FIG. 13 (here, taking the sensing terminal device combination composed of the sensing control terminal device 1 and the sensing assistance terminal device 2 as an example, it is actually applicable to the scenario without the sensing terminal device combination), the terminal device 2 may need to switch from the current communication frequency to the target frequency for sensing so as to perform measurement and to perform reporting in a corresponding window. For example, the communication frequency between the sensing control terminal device 1 and the sensing assistance terminal device 2 is a communication frequency 1, the sensing frequency is a sensing frequency 2 (corresponding to the above-described first frequency), and the candidate frequencies for sensing are candidate frequencies f3 and fn (corresponding to the above-described one or more second frequencies) for sensing. Here, there may be a detection target (i.e., a sensed object) between the sensing control terminal device 1 and the sensing assistance terminal device 2. As described above, the frequency used for communication between the sensing control terminal device 1 and the sensing assistance terminal device 2 is f1, and the frequency used for measuring the sensing signal is f2. Here, there may be a detection target (i.e., a sensed object) between the sensing control terminal device 1 and the sensing assistance terminal device 2.

FIG. 14 is a schematic diagram showing a sensing window according to an embodiment of the disclosure. As shown in FIG. 14, the sensing assistance terminal device 2 measures a sensing signal using a frequency f2 in the ISAC window, and communicates with the sensing control terminal device 1 at the current communication frequency f1.

### Processing and Reporting of Sensing Measurement Results:

As to the processing and reporting of sensing measurement results, processing of interference measurement results by the sensing assistance terminal device 2 is mainly introduced herein, because other sensing measurement results can be directly reported in corresponding sensing windows.

The sensing assistance terminal device 2 may process the interference measurement results in ways as follows.

The sensing assistance terminal device 2 selects one or several frequencies where the interference is relatively small, and reports information of these frequencies to the sensing control terminal device 1, and the sensing control terminal device 1 decides which operating frequency to adopt in subsequent ISAC. In this process, the sensing control terminal device 1 may configure a number of frequencies to be measured and reported by the sensing assistance terminal device 2.

Alternatively, the sensing assistance terminal device 2 directly reports the measurement result of each frequency to the sensing control terminal device 1, so that the sensing control terminal device 1 selects the target frequency.

Alternatively, the sensing control terminal device 1 configures a quality threshold of the reported frequency, such as interference strength, SNR or the like, and only the frequency meeting the threshold requirement can be reported.

The sensing control terminal device 1's processing of interference results reported by the sensing assistance terminal device 2: the sensing control terminal device 1 selects a frequency for performing the ISAC from the measurement results of the sensing assistance terminal device 2, and notifies the sensing assistance terminal device 2 of the selected frequency.

### Embodiment 2: Interference Avoidance Based on Beam Switching in ISAC

In the embodiment 1, the implementation manner of the ISAC, the measurement parameters of the ISAC and the like are introduced. The measurement parameters include measurement parameters for interference avoidance, and the selection of frequencies with small interference by switching between multiple frequencies to achieve high-quality ISAC and the interference avoidance measures for the ISAC between terminal devices are also introduced. In the embodiment 2, an interference avoidance method based on beam switching will be described. Since most of the basic sensing configuration processes are similar, only the differences are introduced herein.

The interference avoidance method based on beam switching is similar to the interference avoidance method based on frequency in that the switching to a candidate frequency or beam is realized through the measurement feedback of the sensing assistance terminal device on multiple candidate frequencies or beams, so as to achieve the purpose of avoiding interference.

FIG. 15 is a schematic diagram showing beam-based sensing according to an embodiment of the disclosure. As shown in FIG. 15, the sensing control terminal device and the sensing assistance terminal device perform communication and sensing through a wide beam, the sensing control terminal device 1 emits a beam 0, the sensing assistance terminal device 2 measures the strength, SNR and the like of a received signal of the beam 0, and feeds back the measurement results to the terminal device 1. Here, there may be a detection target (i.e., a sensed object) between the sensing control terminal device 1 and the sensing assistance terminal device 2.

In some embodiments, if the measurement result shows that the interference is relatively strong or the signal is relatively weak, the sensing control terminal device 1 will further attempt to reduce the interference by adopting a narrower beam.

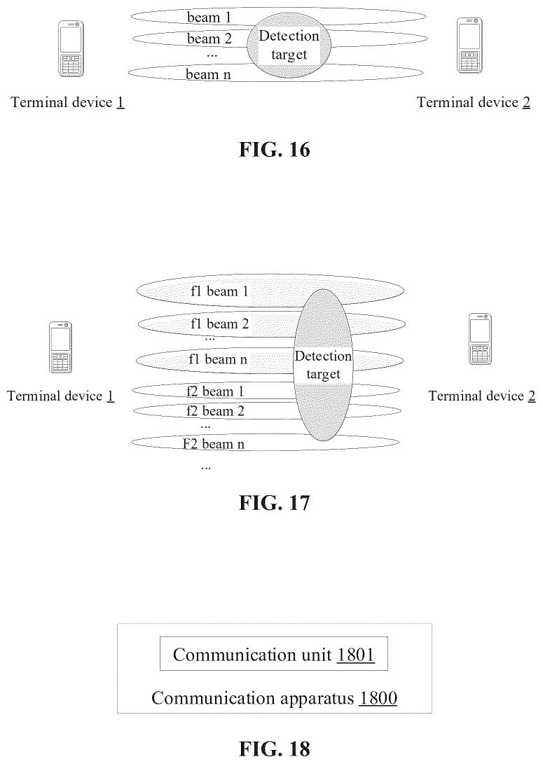

FIG. 16 is a schematic diagram showing another beam-based sensing according to an embodiment of the disclosure. As shown in FIG. 16, the sensing control terminal device 1 emits beams 1, 2 . . . n, and the sensing assistance terminal device 2 measures the signal strength, SNR or the like on beam 1 to beam n, feeds back the measurement results to the sensing control terminal device 1 (the feedback result may be the signal strength or SNR on each beam, or several beams with strong signal strengths or low SNR selected by the sensing assistance terminal device 2, etc.), and selects the beam used for subsequent detection. Since the strength of interference on each beam changes dynamically, while sensing and detecting, the sensing control terminal device 1 needs to configure a plurality of beam measurement targets to the sensing assistance terminal device 2 to dynamically monitor the signal strength or SNR on the beam, so as to perform beam switching at an appropriate time. Here, there may be a detection target (i.e., a sensed object) between the sensing control terminal device 1 and the sensing assistance terminal device 2.

Compared with the embodiment 1, the embodiment has differences in the following aspects: in order to distinguish beams, each beam needs to have an identifier, which is identified by a beam ID herein, such as beam 0, beam 1, beam 2 . . . ; and the configuration related to sensing measurement, which mainly includes contents such as target beam, measurement quantity for sensing, and reporting of sensing measurement result. Herein, the target frequency is replaced with the target beam, the candidate frequencies f1, f2 . . . fn for ISAC are replaced with candidate beams; and other replacements are similar.

### Embodiment 3: Interference Avoidance Based on Frequency Switching and Beam Switching in ISAC

A new interference avoidance method can be obtained by combining the contents of the embodiment 1 and the embodiment 2, that is, a method of obtaining interference avoidance by combining two dimensions of frequency and beam.

In the embodiment 1, interference avoidance is performed only from the dimension of frequency switching, and in the embodiment 2, interference avoidance is performed by beam switching. Here, the embodiment 3 is based on the embodiment 1 and a corresponding group of beams are introduced to each frequency, so as to realize the combination of frequency and beam.

FIG. 17 is a schematic diagram showing ISAC and interference avoidance based on the combination of frequency and beam according to an embodiment of the disclosure. As shown in FIG. 17, the sensing control terminal device 1 configures a plurality of target measurement frequencies and measurement beams at each frequency to the sensing assistance terminal device 2. For example, at least one of the following is configured: (f1, beam 1) combination, (f1, beam 2) combination, . . . , (f1, beam n) combination, (f2, beam 1) combination, (f2, beam 2) combination, . . . , (f2, beam n) combination. Here, there may be a detection target (i.e., a sensed object) between the sensing control terminal device 1 and the sensing assistance terminal device 2.

The sensing assistance terminal device 2 performs corresponding measurement of signal strength, SNR, etc. and feeds back to the sensing control terminal device 1 (the feedback information may be results of all frequencies and beams measured, or may be several results having low interference or high SNR selected from the measurement results, or the sensing assistance terminal device may directly feed back several IDs of beams having low interference or high SNR to the sensing control terminal device 1). The sensing control terminal device 1 determines a sensing frequency and a sensing beam, informs them to the sensing assistance terminal device 2, and simultaneously configures a plurality of monitoring frequencies and beams to the terminal device 2 for subsequent dynamic interference monitoring as well as frequency and beam changing.

The embodiments of the disclosure propose: composition of a system for ISAC between terminal devices; a combination of a sensing control terminal device and a sensing assistance terminal device, and an interaction of capability information therebetween; configurations related to sensing measurement; processing and reporting of sensing measurement results; and methods for interference avoidance based on frequency switching, beam switching, and frequency+beam switching. The embodiments of the disclosure can realize ISAC between terminal devices, interference avoidance, and the like.

The preferred embodiments of the disclosure have been described in detail above with reference to the accompanying drawings, but the disclosure is not limited to the specific details in the above-described embodiments. Within the scope of the technical concept of the disclosure, various simple modifications can be made to the technical solutions of the disclosure, and these simple modifications all fall within the scope of protection of the disclosure. For example, various specific technical features described in the above-described detailed description can be combined in any suitable manner without contradiction, and various possible combinations will not be described separately in this application in order to avoid unnecessary repetition. For example, various embodiments of the disclosure may be combined arbitrarily, and as long as they do not violate the idea of the disclosure, they should also be regarded as the disclosure of the disclosure. For another example, on the premise that there is no conflict, each embodiment described in the disclosure and/or the technical features in each embodiment can be arbitrarily combined with the prior art, and the technical solution obtained after the combination should also fall within the scope of protection of the disclosure.

It should also be appreciated that in various method embodiments of the disclosure, the sequence numbers of the above-described processes do not mean a sequence of execution, and the sequence of execution of each process should be determined by its function and internal logic, and the sequence numbers should not constitute any limitation on the implementation process of the embodiments of the disclosure. In addition, in the embodiments of the disclosure, the terms “downlink”, “uplink”, and “sidelink” are used to indicate the transmission direction of signals or data, wherein “downlink” is used to indicate that a transmission direction of signals or data is a first direction transmitted from a station to a UE of the cell, “uplink” is used to indicate that a transmission direction of signals or data is a second direction transmitted from the UE of the cell to the station, and “sidelink” is used to indicate that a transmission direction of signals or data is a third direction transmitted from a UE1 to a UE2. For example, “downlink signal” indicates that the transmission direction of the signal is the first direction. The term “and/or” in the embodiments of the disclosure is only an association relationship between objects, and indicates that there may be three kinds of relationships. Specifically, A and/or B may indicate three situations that A exists alone, A and B exist simultaneously, and B exists alone. In addition, the character “/” in this article generally indicates that the related objects before and after this character are in an “or” relationship.

FIG. 18 is a schematic structural diagram of a communication apparatus according to an embodiment of the disclosure. As shown in FIG. 18, the communication apparatus 1800 includes a communication unit 1801.

The communication unit 1801 is configured to receive first information sent by a second device. The first information is determined according to one or more first measurement results, the one or more first measurement results being determined respectively by measuring a sensing signal according to one or more pieces of sensing parameter information.

The first information indicates first sensing parameter information.

In some embodiments, the communication apparatus 1800 may be applied to a first device.

In some embodiments, the communication apparatus 1800 further includes a determining unit configured to determine a second device.

In some embodiments, the communication unit 1801 is further configured to:
receive a second measurement result sent by the second device, wherein the second measurement result is a measurement result obtained by measuring the sensing signal according to the first sensing parameter information, and the second measurement result is used for determining a sensing result of a sensed object; or,
receive the sensing result of the sensed object sent by the second device, wherein the sensing result of the sensed object is determined according to the second measurement result, the second measurement result being a measurement result obtained by measuring the sensing signal according to the first sensing parameter information; or,
receive a first processing result sent by the second device, wherein the first processing result is used for determining the sensing result of the sensed object, and the first processing result is obtained by processing the second measurement result, the second measurement result being a measurement result obtained by measuring the sensing signal according to the first sensing parameter information.

In some embodiments, the communication unit 1801 is further configured to send second information to the second device, wherein the second information includes the first sensing parameter information, or the second information includes the first sensing parameter information and one or more pieces of second sensing parameter information; and the one or more pieces of second sensing parameter information are used by the second device for switching from measuring the sensing signal according to the first sensing parameter information to measuring the sensing signal according to specific sensing parameter information, the specific sensing parameter information being included in the one or more pieces of second sensing parameter information.

In some embodiments, the first information includes at least one of: at least one piece of sensing parameter information, where the at least one piece of sensing parameter information is included in the one or more pieces of sensing parameter information, and the at least one piece of sensing parameter information is determined according to the one or more first measurement results; at least one first measurement result obtained respectively by measuring the sensing signal according to the at least one piece of sensing parameter information; or the one or more first measurement results.

In some embodiments, the at least one piece of sensing parameter information satisfies at least one of: at least one first measurement value in one-to-one correspondence with the at least one piece of sensing parameter information is greater than or equal to the first threshold; or at least one second measurement value in one-to-one correspondence with the at least one piece of sensing parameter information is smaller than or equal to a second threshold, where at least one of the first measurement value or the second measurement value is included in the first measurement result; the first measurement value includes a measurement value of at least one of: signal receiving power, signal receiving quality, received signal strength, SINR, or SNR; and the second measurement value includes a measurement value of at least one of: interference strength, noise strength, interference plus noise strength, interference power, noise power, or interference plus noise power.

In some embodiments, the communication unit 1801 is further configured to send third information, where the third information is used for instructing the second device to measure the sensing signal.

In some embodiments, the third information includes at least one of: first sensing configuration information, which includes a first set including a first number of pieces of sensing parameter information; first measurement configuration information, which includes at least one of: signal receiving power, signal receiving quality, received signal strength, SINR, SNR, interference strength, noise strength, interference plus noise strength, interference power, noise power, interference plus noise power, Doppler shift, angle parameter, or characteristic information of a sensed object; identification information of the communication apparatus; reporting type configuration information of the first information, where reporting type configuration information of the first information includes one of: configuration information for periodic reporting, and configuration information for event-triggered reporting; configuration information for a first window where the sensing signal is measured, where the configuration information for the first window includes at least one of: a length of the first window, a period of the first window, a start time of the first window, or an end time of the first window; configuration information for a second window where the first information is reported, where the configuration information for the second window includes at least one of: a length of the second window, a period of the second window, a start time of the second window, or an end time of the second window; configuration information for a third window where the sensing signal is measured and the first information is reported, herein the configuration information for the third window includes at least one of: a length of the third window, a period of the third window, a start time of the third window, or an end time of the third window; or the number of pieces of sensing parameter information corresponding to the first information.

In some embodiments, the communication unit 1801 is further configured to receive fourth information or fifth information sent by the second device, herein the fourth information is used for indicating at least one of: first measurement values corresponding to at least part of the sensing parameter information in the first set are greater than or equal to a first threshold, or second measurement values corresponding to at least part of the sensing parameter information in the first set are smaller than or equal to a second threshold; the fifth information is used for indicating at least one of: first measurement values corresponding to all of the sensing parameter information in the first set are smaller than the first threshold, or second measurement values corresponding to all of the sensing parameter information in the first set are greater than the second threshold. Herein, at least one of the first measurement value or the second measurement value is included in the first measurement result; the first measurement value includes a measurement value of at least one of: signal receiving power, signal receiving quality, received signal strength, SINR, or SNR; and the second measurement value includes a measurement value of at least one of: interference strength, noise strength, interference plus noise strength, interference power, noise power, or interference plus noise power.

In some embodiments, the communication unit 1801 is further configured to: in a case the fifth information is received, send sixth information. The sixth information includes at least one of: second sensing configuration information that includes a second set including a second number of pieces of sensing parameter information, where the second set is at least partially different from the first set; first measurement configuration information; identification information of the second device; reporting type configuration information of the first information; configuration information for a first window where the sensing signal is measured; configuration information for a second window where the first information is reported; configuration information for a third window where the sensing signal is measured and the first information is reported; or a number of pieces of sensing parameter information corresponding to the first information.

In some embodiments, the configuration information for event-triggered reporting includes at least one of: a first threshold; or a second threshold. Herein, at least one first measurement value in one-to-one correspondence with the at least one piece of sensing parameter information is greater than or equal to the first threshold; at least one second measurement value in one-to-one correspondence with the at least one piece of sensing parameter information is smaller than or equal to a second threshold, a first measurement value corresponding to current sensing parameter information is smaller than the first threshold; a second measurement value corresponding to the current sensing parameter information is greater than the second threshold. At least one of the first measurement value or the second measurement value is included in the first measurement result; the first measurement value includes a measurement value of at least one of: signal receiving power, signal receiving quality, received signal strength, SINR, or SNR; and the second measurement value includes a measurement value of at least one of: interference strength, noise strength, interference plus noise strength, interference power, noise power, or interference plus noise power.

In some embodiments, the communication unit 1801 is further configured to send a first request, the first request including at least one of: identification information of the communication apparatus 1800, or second measurement configuration information. The second measurement configuration information includes at least one of: signal receiving power, signal receiving quality, received signal strength, SINR, SNR, interference strength, noise strength, interference plus noise strength, interference power, noise power, interference plus noise power, Doppler shift, angle parameter, or characteristic information of a sensed object.

In some embodiments, the communication unit 1801 is further configured to receive seventh information sent by the second device, where the seventh information includes at least one of: identification information of the second device, third measurement configuration information supported by the second device, or a third set supported by the second device, the third set including a third number of pieces of sensing parameter information. The third measurement configuration information includes at least one of: signal receiving power, signal receiving quality, received signal strength, SINR, SNR, interference strength, noise strength, interference plus noise strength, interference power, noise power, interference plus noise power, Doppler shift, angle parameter, or characteristic information of a sensed object; and the third number of pieces of sensing parameter information include the one or more pieces of sensing parameter information.

In some embodiments, the sensing parameter information includes a frequency; the first sensing parameter information includes a first frequency; and the second sensing parameter information includes a second frequency.

In some embodiments, the sensing parameter information includes a spatial filter; the first sensing parameter information includes a first spatial filter; and the second sensing parameter information includes a second spatial filter.

In some embodiments, the sensing parameter information includes a parameter combination including a combination of frequency and spatial filter, and the first sensing parameter information includes a first parameter combination including a combination of a first set of frequencies and a first set of spatial filters, and the second sensing parameter information includes a second parameter combination including a combination of a second set of frequencies and a second set of spatial filters.

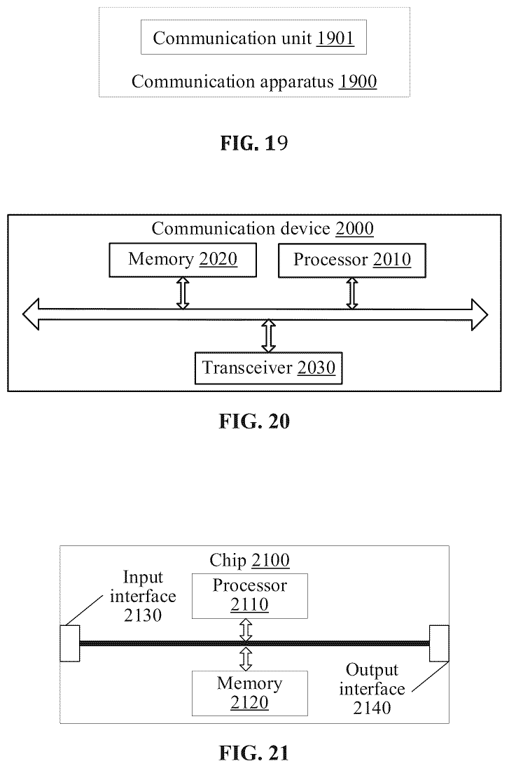

FIG. 19 is a schematic structural diagram of another communication apparatus according to an embodiment of the disclosure. As shown in FIG. 19, the communication apparatus 1900 includes a communication unit 1901.

The communication unit 1901 is configured to send first information to a first device, where the first information is determined according to one or more first measurement results, the one or more first measurement results being determined respectively by measuring a sensing signal according to one or more pieces of sensing parameter information.

The first information indicates first sensing parameter information.

In some embodiments, the communication apparatus 1900 may be applied to a second device.

In some embodiments, the communication apparatus 1900 further includes a measurement unit configured to measure the sensing signal.

In some embodiments, the communication unit 1901 is further configured to:
send a second measurement result to the first device, wherein the second measurement result is a measurement result obtained by measuring the sensing signal according to the first sensing parameter information, and the second measurement result is used for determining a sensing result of a sensed object; or,
send the sensing result of the sensed object to the first device, wherein the sensing result of the sensed object is determined according to the second measurement result, the second measurement result being a measurement result obtained by measuring the sensing signal according to the first sensing parameter information; or,
send a first processing result to the first device, wherein the first processing result is used for determining the sensing result of the sensed object, and the first processing result is obtained by processing the second measurement result, the second measurement result being a measurement result obtained by measuring the sensing signal according to the first sensing parameter information.

In some embodiments, the communication unit 1901 is further configured to receive second information sent by the first device. Herein, the second information includes the first sensing parameter information, or the second information includes the first sensing parameter information and one or more pieces of second sensing parameter information; and the one or more pieces of second sensing parameter information are used by the second device for switching from measuring the sensing signal according to the first sensing parameter information to measuring the sensing signal according to specific sensing parameter information, the specific sensing parameter information being included in the one or more pieces of second sensing parameter information.

In some embodiments, the first information includes at least one of: at least one piece of sensing parameter information, where the at least one piece of sensing parameter information is included in the one or more pieces of sensing parameter information, and the at least one piece of sensing parameter information is determined according to the one or more first measurement results; at least one first measurement result obtained respectively by measuring the sensing signal according to the at least one piece of sensing parameter information; or the one or more first measurement results.

In some embodiments, the at least one piece of sensing parameter information satisfies at least one of: at least one first measurement value in one-to-one correspondence with the at least one piece of sensing parameter information is greater than or equal to the first threshold; or at least one second measurement value in one-to-one correspondence with the at least one piece of sensing parameter information is smaller than or equal to a second threshold, where at least one of the first measurement value or the second measurement value is included in the first measurement result; the first measurement value includes a measurement value of at least one of: signal receiving power, signal receiving quality, received signal strength, SINR, or SNR; and the second measurement value includes a measurement value of at least one of: interference strength, noise strength, interference plus noise strength, interference power, noise power, or interference plus noise power.

In some embodiments, the communication unit 1901 is further configured to receive third information sent by the first device, where the third information is used for instructing the second device to measure the sensing signal.

In some embodiments, the third information includes at least one of: first sensing configuration information, which includes a first set; first measurement configuration information, which includes at least one of: signal receiving power, signal receiving quality, received signal strength, SINR, SNR, interference strength, noise strength, interference plus noise strength, interference power, noise power, interference plus noise power, Doppler shift, angle parameter, or characteristic information of a sensed object; identification information of the communication apparatus 1900; reporting type configuration information of the first information, where the reporting type configuration information of the first information includes one of: configuration information for periodic reporting, and configuration information for event-triggered reporting; configuration information for a first window where the sensing signal is measured, where the configuration information for the first window includes at least one of: a length of the first window, a period of the first window, a start time of the first window, or an end time of the first window; configuration information for a second window where the first information is reported, where the configuration information for the second window includes at least one of: a length of the second window, a period of the second window, a start time of the second window, or an end time of the second window; configuration information for a third window where the sensing signal is measured and the first information is reported, herein the configuration information for the third window includes at least one of: a length of the third window, a period of the third window, a start time of the third window, or an end time of the third window; or the number of pieces of sensing parameter information corresponding to the first information.

In some embodiments, the communication unit 1901 is further configured to send fourth information or fifth information to the first device. Herein, the fourth information is used for indicating at least one of: first measurement values corresponding to at least part of the sensing parameter information in the first set are greater than or equal to a first threshold, or second measurement values corresponding to at least part of the sensing parameter information in the first set are smaller than or equal to a second threshold; the fifth information is used for indicating at least one of: first measurement values corresponding to all of the sensing parameter information in the first set are smaller than the first threshold, or second measurement values corresponding to all of the sensing parameter information in the first set are greater than the second threshold. Herein, at least one of the first measurement value or the second measurement value is included in the first measurement result; the first measurement value includes a measurement value of at least one of: signal receiving power, signal receiving quality, received signal strength, SINR, or SNR; and the second measurement value includes a measurement value of at least one of: interference strength, noise strength, interference plus noise strength, interference power, noise power, or interference plus noise power.

In some embodiments, the communication unit 1901 is further configured to: in a case the fifth information is sent, receive sixth information sent by the first device. The sixth information includes at least one of: second sensing configuration information that includes a second set, where the second set is at least partially different from the first set; first measurement configuration information; identification information of the second device; reporting type configuration information of the first information; configuration information for a first window where the sensing signal is measured; configuration information for a second window where the first information is reported; configuration information for a third window where the sensing signal is measured and the first information is reported; or a number of pieces of sensing parameter information corresponding to the first information.

In some embodiments, the configuration information for event-triggered reporting includes at least one of: a first threshold; or a second threshold. Herein, at least one first measurement value in one-to-one correspondence with the at least one piece of sensing parameter information is greater than or equal to the first threshold; at least one second measurement value in one-to-one correspondence with the at least one piece of sensing parameter information is smaller than or equal to a second threshold, a first measurement value corresponding to current sensing parameter information is smaller than the first threshold; a second measurement value corresponding to the current sensing parameter information is greater than the second threshold. At least one of the first measurement value or the second measurement value is included in the first measurement result; the first measurement value includes a measurement value of at least one of: signal receiving power, signal receiving quality, received signal strength, SINR, or SNR; and the second measurement value includes a measurement value of at least one of: interference strength, noise strength, interference plus noise strength, interference power, noise power, or interference plus noise power.

In some embodiments, the communication unit 1901 is further configured to receive a first request sent by the first device, the first request including at least one of: identification information of the first device, or second measurement configuration information. The second measurement configuration information includes at least one of: signal receiving power, signal receiving quality, received signal strength, SINR, SNR, interference strength, noise strength, interference plus noise strength, interference power, noise power, interference plus noise power, Doppler shift, angle parameter, or characteristic information of a sensed object.

In some embodiments, the communication unit 1901 is further configured to send seventh information to the first device, where the seventh information includes at least one of: identification information of the communication apparatus 1900, third measurement configuration information supported by the communication apparatus 1900, or a third set supported by the communication apparatus 1900. The third measurement configuration information includes at least one of: signal receiving power, signal receiving quality, received signal strength, SINR, SNR, interference strength, noise strength, interference plus noise strength, interference power, noise power, interference plus noise power, Doppler shift, angle parameter, or characteristic information of a sensed object; and the third set includes the one or more pieces of sensing parameter information.

In some embodiments, the sensing parameter information includes a frequency; the first sensing parameter information includes a first frequency; and the second sensing parameter information includes a second frequency.

In some embodiments, the sensing parameter information includes a spatial filter; the first sensing parameter information includes a first spatial filter; and the second sensing parameter information includes a second spatial filter.

In some embodiments, the sensing parameter information includes a parameter combination including a combination of frequency and spatial filter, and the first sensing parameter information includes a first parameter combination including a combination of a first set of frequencies and a first set of spatial filters, and the second sensing parameter information includes a second parameter combination including a combination of a second set of frequencies and a second set of spatial filters.

Those skilled in the art should understand that the related description of the above-described communication apparatus according to the embodiments of the disclosure can be understood with reference to the related description of the communication method according to the embodiments of the disclosure.

FIG. 20 is a schematic structural diagram of a communication device according to an embodiment of the disclosure, and the communication device 2000 may include a first device or a second device. The communication device 2000 shown in FIG. 20 may include a processor 2010, a memory 2020 and a transceiver 2030; and the memory 2020 is configured to store a computer program, and the processor 2010 is configured to invoke and execute the computer program stored in the memory 2020 to cooperate with the transceiver 2030 to perform the method in any one of the above embodiments.

Optionally, the memory 2020 may be a separate device independent of the processor 2010, or may be integrated in the processor 2010. In some embodiments, the processor 2010 may control the transceiver 2030 to communicate with other devices. Specifically, the processor 2010 may control the transceiver 2030 to send information or data to other devices, or receive information or data sent by other devices. Herein, the transceiver 2030 may include a transmitter and a receiver. The transceiver 2030 may further include antennas, and the number of antennas may be one or more. In some embodiments, the communication device 2000 may specifically be the first device in the embodiments of the disclosure, and the communication device 2000 may perform corresponding processes performed by the network device in each method of the embodiments of the disclosure, which will not be described herein for the sake of brevity. In some embodiments, the communication device 2000 may specifically be the second device in the embodiments of the disclosure, and the communication device 2000 may perform corresponding processes performed by the second device in each method of the embodiments of the disclosure, which will not be described herein for the sake of brevity.

The embodiments of the disclosure provide a computer storage medium storing one or more programs executable by one or more processors to perform the method according to any one embodiment of the disclosure.

In some embodiments, the computer-readable storage medium can be applied to the first device or the second device in the embodiment of the disclosure, and the computer program causes the computer to perform corresponding processes performed by the first device or the second device in each method of the embodiment of the disclosure, which will not be described herein for the sake of brevity.

FIG. 21 is a schematic structural diagram of a chip according to an embodiment of the disclosure. The chip 2100 shown in FIG. 21 includes a processor 2110 for invoking and running a computer program from a memory to perform the method according to any embodiment of the disclosure. In some embodiments, as shown in FIG. 21, the chip 2100 may further include a memory 2120. Herein, the processor 2110 may invoke and run a computer program from the memory 2120 to perform the method in the embodiment of the disclosure. Herein, the memory 2120 may be a separate device independent of the processor 2110, or may be integrated in the processor 2110. In some embodiments, the chip 2100 may further include an input interface 2130. The processor 2110 may control the input interface 2130 to communicate with other devices or chips. Specifically, the processor 2110 may control the input interface 2130 to acquire information or data sent by other devices or chips. In some embodiments, the chip 2100 may further include an output interface 2140. The processor 2110 may control the output interface 2140 to communicate with other devices or chips. Specifically, the processor 2110 may control the output interface 2140 to output information or data to other devices or chips.

In some embodiments, the chip can be applied to the first device in the embodiments of the disclosure, and the chip may perform corresponding processes performed by the first device in each method of the embodiments of the disclosure, which will not be described herein for the sake of brevity.

In some embodiments, the chip can be applied to the second device in the embodiments of the disclosure, and the chip can implement corresponding processes implemented by the second device in each method of the embodiment of the disclosure, and will not be repeatedly described here for the sake of brevity.

It should be understood that the chip mentioned in the embodiments of the disclosure may also be referred to as a system-level chip, a system chip, a chip system, an SoC (system on chip) chip, or the like.

The embodiments of the disclosure provide a computer program product, including a computer storage medium storing a computer program that includes instructions executable by at least one processor, and the method according to any one of the embodiments of the disclosure is performed when the instructions are executed by the at least one processor.

In some embodiments, the compute program product can be applied to the first device or the second device in the embodiment of the disclosure, and the computer program instructions cause the computer to perform corresponding processes performed by the first device or the second device in each method of the embodiment of the disclosure, which will not be described herein for the sake of brevity.

Optionally, the computer program product in the embodiments of the disclosure may also be referred to as a software product in other embodiments.

The embodiments of the disclosure further provide a computer program that causes a computer to perform the communication method according to any one of the embodiments of the disclosure.

In some embodiments, the compute program can be applied to the first device or the second device in the embodiment of the disclosure, and the computer program, when run on a computer, causes the computer to perform corresponding processes performed by the first device or the second device in each method of the embodiment of the disclosure, which will not be described herein for the sake of brevity.

The processor, communication apparatus, or chip according to the embodiments of the disclosure may be an integrated circuit chip having signal processing capabilities. In the implementation process, the operations of the above-described method embodiments may be performed by integrated logic circuits of hardware in the processor or instructions in the form of software. The processor, communication apparatus, or chip described above may include an integration of any one or more of a general purpose processor, an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a Graphics Processing Unit (GPU), Embedded neural network processors (NPUs), controllers, microcontrollers, microprocessors, programmable logic devices, discrete gate or transistor logic devices, discrete hardware components. The methods, operations, and logical block diagrams disclosed in the embodiments of the disclosure may be implemented or executed. The general-purpose processor may be a microprocessor or the processor may be any conventional processor or the like. The steps of the method disclosed in connection with the embodiments of the disclosure may be directly embodied as execution by the hardware decoding processor, or may be executed by combining hardware and software modules in the decoding processor. The software module may be located in a storage medium mature in the art, such as random access memory, flash memory, read-only memory, programmable read-only memory, or electrically erasable and writable programmable memory, registers, etc. The storage medium is located in the memory, and the processor reads the information in the memory, and combines its hardware to complete the steps of the above method.

It should be appreciated that the memory or computer storage medium according to the embodiments of the disclosure may be a volatile memory or a non-volatile memory, or may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM) used an external high speed cache. By way of illustration, but not by way of limitation, many forms of RAM are available, such as Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), and Direct Rambus RAM (DR RAM). It should be noted that the memory of the systems and methods described herein is intended to include, but is not limited to, these and any other suitable type of memory.

It should be understood that the above-described memory or computer storage medium is an illustrative but not limiting illustration, for example, the memory in the embodiments of the disclosure may also be a static random access memory (SRAM), a dynamic random access memory (DRAM), a synchronous dynamic random access memory (SDRAM), a double data rate synchronous dynamic random access memory (DDRAM), an enhanced SDRAM (ESDRAM), a synch link dynamic random access memory (SLDRAM), a Direct Rambus RAM (DR RAM), and the like. That is to say, the memory described in embodiments of the disclosure is intended to include any suitable type of memory.

Those of ordinary skill in the art will appreciate that the elements and algorithmic steps of the various examples described in connection with the embodiments disclosed herein can be implemented in electronic hardware, or a combination of computer software and electronic hardware. Whether these functions are performed in hardware or software depends on the specific application and design constraints of the technical solution. Those skilled in the art may use different methods for implementing the described functions for each particular application, but such implementations should not be considered beyond the scope of the disclosure.

Those skilled in the art can clearly understand that for convenience and conciseness of the description, for the specific working processes of the systems, devices, and units described above, reference may be made to the corresponding processes in the aforementioned method embodiments, and will not be repeatedly described herein.

It should be understood that the systems, apparatuses and methods disclosed in various embodiments of the disclosure may be implemented in other ways. For example, the device embodiments described above are merely schematic. For example, the division of units is only a division in terms of logical functions, and there may be other division methods in actual implementations. For example, multiple units or components may be combined or integrated into another system, or some features may be ignored or not implemented. In addition, the coupling or direct coupling or communication connection between each other shown or discussed herein may be an indirect coupling, or a communication connection through some interfaces, devices or units, and the coupling or communication connection may be electrical, mechanical or in other forms.

The units described as separate units may or may not be physically separate, and the units displayed as units may or may not be physical units. That is to say, they may be located in one place or may be distributed over multiple network units. Some or all of the units may be selected according to actual needs to achieve the purpose of the schemes of the embodiments.

In addition, functional units in various embodiments of the disclosure may be integrated in one processing unit, may be physically present separately, or two or more units may be integrated in one unit.

In any embodiment of the disclosure, a time interval, a time period, within a time range, within a time period, within a time window, etc. may include all of endpoint times, or may include part of the endpoint times (for example, including a left endpoint time but not including a right endpoint time, or including the right endpoint time but not including the left endpoint time), or may not include the endpoint times.

The functions may be stored in a computer-readable storage medium if implemented in the form of software functional units and sold or used as independent products. Based on this understanding, the technical solution of the disclosure essentially or a part that contributes to the prior art or a part of the technical solution may be embodied in the form of a software product, which is stored in a storage medium and includes several instructions for causing a computer device (which may be a personal computer, a server, or a network device, etc.) to perform all or part of the steps of the method described in various embodiments of the disclosure. The storage medium includes various media that can store program codes, such as a USB disk, a removable hard disk, a Read-Only Memory (ROM), a Random Access Memory (RAM), a magnetic disk, or an optical disk.

The foregoing describes merely specific implementations of the disclosure, but the scope of protection of the disclosure is not limited thereto. Any person skilled in the art can readily conceive of changes or substitutions within the technical scope disclosed in the disclosure, all of which fall within the scope of protection of the disclosure. Therefore, the scope of protection of the disclosure should be based on the scope of protection of the claims.

1. A communication method, comprising:
receiving, by a first device, first information sent by a second device, wherein the first information is determined according to one or more first measurement results, the one or more first measurement results being determined respectively by measuring a sensing signal according to one or more pieces of sensing parameter information,
wherein the first information indicates first sensing parameter information.

2. The method of claim 1, further comprising:
receiving, by the first device, a second measurement result sent by the second device, wherein the second measurement result is a measurement result obtained by measuring the sensing signal according to the first sensing parameter information, and the second measurement result is used for determining a sensing result of a sensed object; or,
receiving, by the first device, the sensing result of the sensed object sent by the second device, wherein the sensing result of the sensed object is determined according to the second measurement result, the second measurement result being a measurement result obtained by measuring the sensing signal according to the first sensing parameter information; or,
receiving, by the first device, a first processing result sent by the second device, wherein the first processing result is used for determining the sensing result of the sensed object, and the first processing result is obtained by processing the second measurement result, the second measurement result being a measurement result obtained by measuring the sensing signal according to the first sensing parameter information.

3. The method of claim 1, further comprising:
sending, by the first device, second information, wherein the second information comprises the first sensing parameter information, or the second information comprises the first sensing parameter information and one or more pieces of second sensing parameter information; and the one or more pieces of second sensing parameter information are used by the second device for switching from measuring the sensing signal according to the first sensing parameter information to measuring the sensing signal according to specific sensing parameter information, the specific sensing parameter information being comprised in the one or more pieces of second sensing parameter information.

4. The method of claim 1, wherein the first information comprises at least one of:
at least one piece of sensing parameter information, wherein the at least one piece of sensing parameter information is comprised in the one or more pieces of sensing parameter information, and the at least one piece of sensing parameter information is determined according to the one or more first measurement results;
at least one first measurement result obtained respectively by measuring the sensing signal according to the at least one piece of sensing parameter information; or
the one or more first measurement results.

5. The method of claim 4, wherein the at least one piece of sensing parameter information satisfies at least one of:
at least one first measurement value in one-to-one correspondence with the at least one piece of sensing parameter information is greater than or equal to a first threshold; or
at least one second measurement value in one-to-one correspondence with the at least one piece of sensing parameter information is smaller than or equal to a second threshold,
wherein at least one of the first measurement value or the second measurement value is comprised in the first measurement result;
the first measurement value comprises a measurement value of at least one of: signal receiving power, signal receiving quality, received signal strength, Signal to Interference plus Noise Ratio (SINR), or Signal-to-Noise Ratio (SNR); and
the second measurement value comprises a measurement value of at least one of: interference strength, noise strength, interference plus noise strength, interference power, noise power, or interference plus noise power.

6. The method of claim 1, further comprising:
sending, by the first device, a first request, wherein the first request comprises at least one of: identification information of the first device, or second measurement configuration information,
wherein the second measurement configuration information comprises at least one of: signal receiving power, signal receiving quality, received signal strength, SINR, SNR, interference strength, noise strength, interference plus noise strength, interference power, noise power, interference plus noise power, Doppler shift, angle parameter, or characteristic information of a sensed object.

7. The method of claim 1, further comprising:
receiving, by the first device, seventh information sent by the second device, wherein the seventh information comprises at least one of: identification information of the second device, third measurement configuration information supported by the second device, or a third set supported by the second device, the third set comprising a third number of pieces of sensing parameter information;
wherein the third measurement configuration information comprises at least one of: signal receiving power, signal receiving quality, received signal strength, SINR, SNR, interference strength, noise strength, interference plus noise strength, interference power, noise power, interference plus noise power, Doppler shift, angle parameter, or characteristic information of a sensed object; and
the third number of pieces of sensing parameter information comprise the one or more pieces of sensing parameter information.

8. A communication method, comprising:
sending, by a second device, first information to a first device, wherein the first information is determined according to one or more first measurement results, the one or more first measurement results being determined respectively by measuring a sensing signal according to one or more pieces of sensing parameter information,
wherein the first information indicates first sensing parameter information.

9. The method of claim 8, further comprising:
receiving, by the second device, third information sent by the first device, wherein the third information is used for instructing the second device to measure the sensing signal.

10. The method of claim 9, wherein the third information comprises at least one of:
first sensing configuration information, which comprises a first set;
first measurement configuration information, which comprises at least one of: signal receiving power, signal receiving quality, received signal strength, SINR, SNR, interference strength, noise strength, interference plus noise strength, interference power, noise power, interference plus noise power, Doppler shift, angle parameter, or characteristic information of a sensed object;
the identification information of the second device;
reporting type configuration information of the first information, wherein the reporting type configuration information of the first information comprises one of: configuration information for periodic reporting, and configuration information for event-triggered reporting;
configuration information for a first window where the sensing signal is measured, wherein the configuration information for the first window comprises at least one of: a length of the first window, a period of the first window, a start time of the first window, or an end time of the first window;
configuration information for a second window where the first information is reported, wherein the configuration information for the second window comprises at least one of: a length of the second window, a period of the second window, a start time of the second window, or an end time of the second window;
configuration information for a third window where the sensing signal is measured and the first information is reported, wherein the configuration information for the third window comprises at least one of: a length of the third window, a period of the third window, a start time of the third window, or an end time of the third window; or
the number of pieces of sensing parameter information corresponding to the first information.

11. The method of claim 10, further comprising: sending, by the second device, fourth information or fifth information to the first device,
wherein the fourth information is used for indicating at least one of:
first measurement values corresponding to at least part of the sensing parameter information in the first set are greater than or equal to a first threshold; or
second measurement values corresponding to at least part of the sensing parameter information in the first set are smaller than or equal to a second threshold;
the fifth information is used for indicating at least one of:
first measurement values corresponding to all of the sensing parameter information in the first set are smaller than the first threshold;
second measurement values corresponding to all of the sensing parameter information in the first set are greater than the second threshold,
wherein at least one of the first measurement value or the second measurement value is comprised in the first measurement result;
the first measurement value comprises a measurement value of at least one of: signal receiving power, signal receiving quality, received signal strength, SINR, or SNR; and
the second measurement value comprises a measurement value of at least one of: interference strength, noise strength, interference plus noise strength, interference power, noise power, or interference plus noise power.

12. The method of claim 11, further comprising: when the second device sends the fifth information, receiving, by the second device, sixth information sent by the first device, wherein the sixth information comprises at least one of:
second sensing configuration information, which comprises a second set, wherein the second set is at least partially different from the first set;
the first measurement configuration information;
the identification information of the second device;
the reporting type configuration information of the first information;
the configuration information for the first window where the sensing signal is measured;
the configuration information for the second window where the first information is reported;
the configuration information for the third window where the sensing signal is measured and the first information is reported; or
the number of pieces of sensing parameter information corresponding to the first information.

13. The method of claim 10, wherein the configuration information for event-triggered reporting comprises at least one of:
a first threshold; or
a second threshold;
wherein at least one first measurement value in one-to-one correspondence with the at least one piece of sensing parameter information is greater than or equal to the first threshold;
at least one second measurement value in one-to-one correspondence with the at least one piece of sensing parameter information is smaller than or equal to a second threshold,
a first measurement value corresponding to current sensing parameter information is smaller than the first threshold;
a second measurement value corresponding to the current sensing parameter information is greater than the second threshold;
wherein at least one of the first measurement value or the second measurement value is comprised in the first measurement result; the first measurement value comprises a measurement value of at least one of: signal receiving power, signal receiving quality, received signal strength, SINR, or SNR; and
the second measurement value comprises a measurement value of at least one of: interference strength, noise strength, interference plus noise strength, interference power, noise power, or interference plus noise power.

14. The method of claim 8, wherein the sensing parameter information comprises frequency, and
the first sensing parameter information comprises a first frequency, and the second sensing parameter information comprises a second frequency.

15. A first device, comprising: a processor, a memory, and a transceiver,
wherein the memory is configured to store a computer program; and
the processor is configured to invoke and run the computer program stored in the memory to cooperate with the transceiver to perform an operation of:
receiving first information sent by a second device, wherein the first information is determined according to one or more first measurement results, the one or more first measurement results being determined respectively by measuring a sensing signal according to one or more pieces of sensing parameter information,
wherein the first information indicates first sensing parameter information.

16. The first device of claim 15, wherein the processor is configured to invoke and run the computer program stored in the memory to cooperate with the transceiver to further perform an operation of:
receiving a second measurement result sent by the second device, wherein the second measurement result is a measurement result obtained by measuring the sensing signal according to the first sensing parameter information, and the second measurement result is used for determining a sensing result of a sensed object; or,
receiving the sensing result of the sensed object sent by the second device, wherein the sensing result of the sensed object is determined according to the second measurement result, the second measurement result being a measurement result obtained by measuring the sensing signal according to the first sensing parameter information; or,
receiving a first processing result sent by the second device, wherein the first processing result is used for determining the sensing result of the sensed object, and the first processing result is obtained by processing the second measurement result, the second measurement result being a measurement result obtained by measuring the sensing signal according to the first sensing parameter information.

17. The first device of claim 15, wherein the processor is configured to invoke and run the computer program stored in the memory to cooperate with the transceiver to further perform an operation of:
sending second information to the second device, wherein the second information comprises the first sensing parameter information, or the second information comprises the first sensing parameter information and one or more pieces of second sensing parameter information;
and the one or more pieces of second sensing parameter information are used by the second device for switching from measuring the sensing signal according to the first sensing parameter information to measuring the sensing signal according to specific sensing parameter information, the specific sensing parameter information being comprised in the one or more pieces of second sensing parameter information.

18. The first device of claim 15, wherein the first information comprises at least one of:
at least one piece of sensing parameter information, wherein the at least one piece of sensing parameter information is comprised in the one or more pieces of sensing parameter information, and the at least one piece of sensing parameter information is determined according to the one or more first measurement results;
at least one first measurement result obtained respectively by measuring the sensing signal according to the at least one piece of sensing parameter information; or
the one or more first measurement results.

19. The first device of claim 15, wherein the sensing parameter information comprises spatial filter, and
the first sensing parameter information comprises a first spatial filter, and the second sensing parameter information comprises a second spatial filter.

20. The first device of claim 15, wherein the sensing parameter information comprises a parameter combination comprising a combination of frequency and spatial filter, and
the first sensing parameter information comprises a first parameter combination comprising a combination of a first set of frequencies and a first set of spatial filters, and
the second sensing parameter information comprises a second parameter combination comprising a combination of a second set of frequencies and a second set of spatial filters.
